(19) United States
(12) Patent Application Publication
(10) Pub. No.: US 2008/0261165 A1
(43) Pub. Date: Oct. 23, 2008

(54) Systems for haptic design of dental restorations

(76) Inventors: Bob Steingart, Wellesley, MA (US); Curt Rawley, Windham, NH (US); Craig Cook, Wayland, MA (US); Brandon Itkowitz, Sunnyvale, CA (US); Robert Kittler, Bedford, NH (US); Brian James, Boston, MA (US); Brian Cooper, Foxboro, MA (US)

Correspondence Address: GOODWIN PROCTER LLP;PATENT ADMINISTRATOR, EXCHANGE PLACE, BOSTON, MA, 02109-2881, US

(21) Appl. No.: 11/998,457

(22) Filed: Nov. 28, 2007

Related U.S. Application Data
(60) Provisional application No. 60/861,589, filed on Nov. 28, 2006.

(51) Int. Cl. A61C 7/00

(52) U.S. Cl. 433/24

(57) ABSTRACT

The invention provides systems for integrated haptic design and fabrication of dental restorations that provide significant advantages over traditional practice and existing computer-based systems. The systems feature technical advances that result in significantly more streamlined, versatile, and efficient design and fabrication of dental restorations. Among these technical advances are the introduction of voxel-based models; the use of a combination of geometric representations such as voxels and NURBS representations; the automatic identification of an initial preparation (prep) line and an initial path of insertion; the ability of a user to intuitively, haptically adjust the initial prep line and/or the initial path of insertion; the automatic identification of occlusions and draft angle conflicts (e.g., undercuts); the haptic simulation and/or marking of occlusions and draft angle conflicts; and coordination between design output and rapid prototyping/milling and/or investment casting.

### RELATED APPLICATIONS

This invention claims priority to and benefit of U.S. Provisional Patent Application No. 60/861,589, filed on Nov. 28, 2006, the text of which is incorporated herein by reference in its entirety.

### FIELD OF THE INVENTION

This invention relates generally to systems and tools for dental restoration. More particularly, in certain embodiments, the invention relates to a system for haptic, digital design and integrated fabrication of dental restorations.

### BACKGROUND OF THE INVENTION

Restorative dental treatments typically require multiple dental visits and may take three weeks or more to complete. For example, a first patient visit may involve preparing the tooth, taking an impression with a hardening gel, and fitting a temporary restoration on the tooth. The impression is sent to a dental lab that prepares a plaster positive, a wax-up model, a metal cast, and finally the porcelain restoration. Preparing restorations from a physical impression may involve significant trial and error, and it may be necessary to fabricate multiple porcelain restorations before a proper restoration is made. Multiple patient visits may be required to adjust the temporary, remove the temporary, and install the restoration. Further patient visits may be required if the restoration does not fit properly, in which case the process starts all over again, and a new porcelain restoration must be fabricated.

Computer-based systems have been developed to streamline parts of the dental restoration process, particularly the preparation of the restoration at the dental lab. Systems including Lava™ (3M ESPE Dental), KaVo dental simulation units, Procera™ (Nobel Biocare), Cercon™ (Dentsply), in-Lab™ (Siriona), U-Best Dental™ (Pou Chen), ShadeScan™ (Cynovad), 3Shape Dental Solutions, Materialise systems, DelCAM systems, and Geomagic systems are geared toward computer-based preparation of dental restorations and certain simulation tools for training. The CEREC system (Sirona) is a dental office-based integrated system for fabrication of ceramic dental restorations. However, the system requires significant training by the operator, is not intuitive for use by assistants or mainstream operators, and is not appropriate for preparation of more complex restorations, such as partials, anterior veneers, multi-unit bridges, and custom implant abutments and implant bars.

There is a need for a system to allow intuitive, integrated design of dental restorations—that is, a system that can evaluate a dental restoration problem and fabricate a complex, permanent dental restoration for installation, without excessive trial and error. The system should allow for design adjustments without having to fabricate multiple (physical) dental restorations.

### SUMMARY OF THE INVENTION

The invention provides systems for integrated haptic design and fabrication of dental restorations that provide significant advantages over traditional practice and existing computer-based systems. The systems presented herein are significantly more intuitive than existing dental lab-based digital systems, can handle design and fabrication of more complex dental restorations, and integrate scanning and fitting at the patient location (e.g., a dentist's office) with fabrication either at the patient location or at an off-site dental lab. These systems are intuitive for use by dentists, denial assistants, restoration designers, and/or other operators without significant training in the operation of the systems, and the systems are able to prepare complex restorations such as anterior veneers, multi-unit bridges, and custom implant abutments and implant bars.

The systems feature technical advances that result in significantly more streamlined, versatile, and efficient design and fabrication of dental restorations. Among these technical advances are the introduction of voxel-based models; the use of a combination of geometric representations such as voxels and NURBS representations; the automatic identification of an initial preparation (prep) line and an initial path of insertion; the ability of a user to intuitively, haptically adjust the initial prep line and/or the initial path of insertion; the automatic identification of occlusions and draft angle conflicts (e.g., undercuts); the haptic simulation and/or marking of occlusions and draft angle conflicts; and coordination between design output and rapid prototyping/milling and/or investment casting.

In a first aspect, the invention features a system for creating a three-dimensional dental restoration. Embodiments of the system include a scanner configured to obtain scan data corresponding to a patient situation and/or an impression of a patient situation. Computer software, when operating with a computer and user input, is first configured to create a model of the patient situation according to the scan data, identify a preparation line from the model of the patient situation, and create an initial model of a dental restoration conforming to the preparation line and the scan data. The computer software is further configured to modify the initial model of the dental restoration according to the user input, and determine a force transmitted to a user interacting with the model of the dental restoration via the haptic interface device. The computer software is further configured to provide output data corresponding to the modified model of the dental restoration for fabrication of the three-dimensional dental restoration. A haptic interface device is adapted to provide the user input to the computer and to transmit force to a user. Elements of other aspects of this invention, as described elsewhere herein, may be used in this aspect of the invention as well.

The scanner may be an intra-oral scanner, may comprise multiple light sources and multiple image sensors, and may be a desktop or benchtop scanner. The models of the patient situation and the dental restoration may be haptic models.

The software may be configured to automatically and graphically and/or haptically mark areas on the model of the dental restoration according to occlusions with adjacent and/or opposing teeth, for reference by the user in modifying the model of the dental restoration. The software may also be configured to detect and display draft angle conflicts, for reference by the user in modifying the model of the dental restoration, allowing a user to modify the model of the dental restoration, thereby verifying insertion and/or removal of the three-dimensional dental restoration is possible without undue stress.

The software may also be configured to determine a valid path of insertion of the three-dimensional dental restoration, to fix an undercut of the three-dimensional dental restoration, to automatically identify the preparation line from the model of the patient situation, or to automatically identify an initial preparation line that is adjustable by the user. The initial preparation line may comprise haptic gravity wells for adjustment by the user; the haptic gravity wells may operate on a view apparent basis.

The software may also be configured to allow haptic user interaction with both the model of the patient situation and the model of the dental restoration. The software may also be configured to model different materials using different densities in a voxel-based model, thereby allowing the user to sense a difference between the different materials.

The system may further comprise a rapid prototyping machine used for manufacturing a wax model of the three-dimensional dental restoration using the modified model of the dental restoration. The system may further comprise an investment cast used for manufacturing the three-dimensional dental restoration from the wax model; the three-dimensional dental restoration may be a metal partial framework.

The three-dimensional dental restoration may comprise one or more members selected from the group consisting of a partial, a partial framework, a veneer, a coping, a bridge, a multi-unit bridge, a prosthetic tooth, prosthetic teeth, a pontic, an implant, an implant abutment, and an implant bar. The model of the patient situation and/or the model of the dental restoration may comprise a voxel-based representation.

The software may be configured to generate a NURBS curve approximating the preparation line. The software may comprise a dental specific feature set comprising either one or more or two or more geometrical representations selected from the group consisting of voxel-based, polymesh, NURBS patch, NURBS curve, and polyline geometrical representations. The software may be configured to compensate the model of the dental restoration for material shrinkage during fabrication of the three-dimensional dental restoration.

The scanner may comprise one or more members selected from the group consisting of a visible light scanner, a computed tomography (CT) scanner, a magnetic resonance imaging (MRI) device, and an x-ray machine.

The system may further comprise a client/server networked environment to accommodate workflow between a practice and a dental lab, wherein the output data corresponding to the modified model of the dental restoration is transmitted from the practice to the dental lab for fabrication of the three-dimensional dental restoration.

In a second aspect, the invention features a method for creating a three-dimensional dental restoration. The method includes obtaining a scan of a patient situation or an impression of a patient situation. A haptic computer model of a dental restoration is created based at least in part on the scan. The computer model of the dental restoration is haptically modified. The restoration is fabricated using the haptically modified computer model. Elements of other aspects of this invention, as described elsewhere herein, may be used in this aspect of the invention as well.

The haptic computer model may comprise a voxel-based representation or a voxel-based representation and a NURBS curve approximating a preparation line for the dental restoration. The dental restoration may comprise one or more members selected from the group consisting of a partial, a partial framework, a veneer, a coping, a bridge, a multi-unit bridge, a prosthetic tooth, prosthetic teeth, a pontic, an implant, an implant abutment, and an implant bar.

In a third aspect, the invention features a system for creating a dental restoration. Embodiments of the system include a user-controlled haptic interface device adapted to provide a user input to a computer and to transmit force to a user according to a user interface location in a virtual environment. Computer software (coded instructions), operating with the computer and the user input, is configured to determine force transmitted to the user via the haptic interface device, allow creation and/or manipulation of a voxel-based haptic representation of a 3D dental restoration in the virtual environment, and provide output for milling of the 3D dental restoration following creation and/or manipulation of the voxel-based haptic representation. Elements of other aspects of this invention, as described elsewhere herein, may be used in this aspect of the invention as well.

The system may further comprise a rapid prototyping machine and/or a mill for fabricating the 3D dental restoration. The 3D dental restoration may comprise one or more of the following: a prosthetic tooth, prosthetic teeth, a bridge, a partial, an implant, an implant bar, and an abutment.

In a fourth aspect, a method for creating a dental restoration includes scanning a patient situation and/or an impression of a patient situation. A haptic, voxel-based representation of the patient situation is created, and a haptic, voxel-based representation of a dental restoration adapted for the patient situation is created. The voxel-based representation of the dental restoration is modified, and the dental restoration according to the modified representation is fabricated. Elements of other aspects of this invention, as described elsewhere herein, may be used in this aspect of the invention as well.

In a fifth aspect, the invention features an apparatus for creating a dental restoration. Embodiments of the apparatus include a user-operated haptic interface device and a memory upon which machine-readable code is stored. The code defines a set of instructions for scanning a patient situation and/or an impression of a patient situation, creating a haptic, voxel-based representation of the patient situation, creating a haptic, voxel-based representation of a dental restoration adapted for the patient situation, modifying the voxel-based representation of the dental restoration, and displaying and/or storing the modified representation of the dental restoration. Elements of other aspects of this invention, as described elsewhere herein, may be used in this aspect of the invention as well.

The code may further define instructions for preparing input data from the modified representation of the dental restoration, wherein the input data is usable by a machine for fabrication of the dental restoration.

In one embodiment, the system includes a scanner designed to scan plaster models of a dental patient situation, a modeling application with Haptic device, and a rapid prototyping system (e.g., a 3-D printer). All three devices are connected to a single computer system. The scanned files are represented in a triangular mesh format such as STL, and are input to the haptic modeling system. The resulting restoration design is exported in a triangular mesh format such as an “STL” file, and is sent to the 3D Printer. The printed part from the 3D printer is removed from its “support” material, and if made of metal, is ready for final finishing, otherwise it is investment cast in a fashion similar to that used for hand-waxed models.

A 3D printer creates a physical 3D model from a digital representation in STL format, created out of wax, photopolymer, metal, plaster or other materials. The model is created using an “additive” process, where layers of material are created and “cured” to create the final shape. In some cases “support” material is used under areas of the part which overhang other areas of the part, to support the part in the 3D printing process. These support materials must be removed before using the 3D part.

In another embodiment, the system includes a scanner designed to scan plaster models of a dental patient situation, a modeling application with a haptic device, and a milling machine which is designed to mill 3D parts from various materials, including metal, zirconia, ceramic or composite materials, or wax. All three devices can be connected to a single computer system, or each device may optionally be connected to a separate computer system, or one computer may control 2 of the three components and another computer may control the remaining component. The scanned files are input to the haptic modeling system. The resulting restoration design is exported as a triangular mesh file, such as an “STL” file, and is sent to the milling machine. The part from the 3D milling machine is either in its final form (if made from metal, zirconia, ceramic or composite materials or other appropriate substances), or (if made from wax) is investment cast in a fashion similar to that used today for hand-waxed models.

In any of the embodiments, the scanner may be replaced by an “intra-oral” scanner, used at the dental office, in which case the triangular mesh or STL representation of the patient situation is transferred directly to the modeling system.

### BRIEF DESCRIPTION OF THE DRAWINGS

In the drawings, like reference characters generally refer to the same features throughout the different views. Also, the drawings are not necessarily to scale, emphasis instead being placed upon illustrating the principles of the invention.

FIG. 1A is a block diagram showing elements of a system for the haptic, digital design and fabrication of dental restorations, in accordance with an illustrative embodiment of the invention.

FIG. 1B is a flow chart showing steps in a method for the haptic, digital design and fabrication of dental restorations, in accordance with an illustrative embodiment of the invention.

FIG. 2 is a schematic representation of a hand-held oral scanner capable of creating a three-dimensional representation of an object, in accordance with an illustrative embodiment of the invention.

FIG. 3 is a schematic representation of a PHANTOM® force-feedback haptic interface device, in accordance with an illustrative embodiment of the invention.

FIG. 4 is a polymesh format representation of a scanned tooth preparation that illustrates a margin line, in accordance with an illustrative embodiment of the invention.

FIGS. 5a-5b are representations of a scanned tooth preparation illustrating haptic enabled editing of a margin line using edit points, in accordance with an illustrative embodiment of the invention.

FIGS. 6a-6b are representations of a scanned tooth preparation illustrating selection and modification of a path of insertion, in accordance with an illustrative embodiment of the invention.

FIG. 7 is a representation of a scanned tooth preparation illustrating how an automatic undercut fixing algorithm can fix an undercut, in accordance with an illustrative embodiment of the invention.

FIG. 8 is a screenshot of a modeling application after importing the output of a digital dental scanner, in accordance with an illustrative embodiment of the invention.

FIG. 9 is a screenshot of a modeling application showing a digital tool used to determine a path of insertion, in accordance with an illustrative embodiment of the invention.

FIG. 10 is a screenshot of a modeling application showing an initial digital refractory model with undercuts automatically blocked out, in accordance with an illustrative embodiment of the invention.

FIG. 11 is a screenshot of a modeling application showing the final digital refractory model, including blockout wax and highlighted undercuts, in accordance with an illustrative embodiment of the invention.

FIG. 12 is a screenshot of a modeling application showing a completed digital partial design, after application of digital wax to a digital refractory model, in accordance with an illustrative embodiment of the invention.

FIG. 13 is a screenshot of a modeling application showing a partial frame which may be sent to a 3D printer and/or a mill, in accordance with an illustrative embodiment of the invention.

FIG. 14 is a screenshot of a modeling application showing a scan of a prepared stump for a coping that includes a margin line, in accordance with an illustrative embodiment of the invention.

FIG. 15 is a screenshot of a modeling application showing a digital wax version of a coping, a refractory model of a stump, and a haptic/voxel tug tool, in accordance with an illustrative embodiment of the invention.

FIG. 16 is a screenshot of a modeling application showing a final version of an exported coping that is ready to be sent for rapid prototyping or to a milling machine, in accordance with an illustrative embodiment of the invention.

FIG. 17 is a screenshot of a modeling application showing a case management software screen, which displays information about a particular case, in accordance with an illustrative embodiment of the invention.

FIG. 18 is a screenshot of a modeling application showing a designed bridge with three copings and a haptic/voxel tug tool modifying a pontic, in accordance with an illustrative embodiment of the invention.

FIG. 19 is a screenshot of a modeling application showing a completed bridge on an input scan file, in accordance with an illustrative embodiment of the invention.

FIG. 20 is a screenshot of a modeling application showing a final version of a bridge that is ready to be sent for rapid prototyping or to a milling machine, in accordance with an illustrative embodiment of the invention.

### DETAILED DESCRIPTION

Throughout the description, where processes, systems, and methods are described as having, including, or comprising specific steps and/or components, it is contemplated that, additionally, there are processes, systems, and methods according to the present invention that consist essentially of, or consist of, the recited steps and/or components.

It should be understood that the order of steps or order for performing certain actions is immaterial so long as the invention remains operable. Moreover, two or more steps or actions may be conducted simultaneously.

In certain embodiments, the invention provides an integrated system for dental restoration, where patient evaluation, design of the restoration, and fabrication of the restoration can occur in the same location (e.g., at a dentist's office), or data from the patient location can be relayed offsite to a dental lab for fabrication. In certain embodiments, haptic design also occurs offsite at a dental lab. In certain embodiments, a portion of or the entire the haptic design occurs at the patient location (e.g., dentist's office). In certain embodiments, the system evaluates a dental restoration problem and fabricate a permanent dental restoration for installation, all in one dental visit.

The system can handle restorative treatments including single tooth, multiple tooth, bridges, implants, implant bars, partial frameworks, abutments, and other restorative dental treatments.

The system includes a scanner configured to allow the operator to scan the patient's situation—e.g., the area of the patient's mouth into which a prosthetic device, appliance, or other dental restoration will be fitted (e.g., tooth, teeth, bridge, partial). The system also includes a haptic, voxel-based model for creating, sculpting, carving, and/or otherwise manipulating the modeled dental restoration before it is fabricated. The system also includes a rapid prototyping machine (e.g., a 3-D printer) and/or a mill (e.g., an integrated, desk-top mill) for preparation of the permanent restoration (prosthetic device, appliance, or other dental restoration). Fabrication may occur at the patient location (e.g., allowing “chairside” analysis, design, and fabrication of the dental restoration all in a single patient visit), or fabrication may occur off site at a dental lab.

In addition to the integrated chairside dental restoration system, in certain embodiments, the invention provides a scanner suitable for use in the integrated system, that uses multiple light sources and multiple image sensors to provide volumetric and surface descriptions of dental structures.

Also, in certain embodiments, the invention provides a haptic, voxel-based modeling system, suitable for use in the dental restoration system. The system is a touch-enabled modeling system that allows the operator to create complex, organic shapes faster and easier than with traditional CAD systems. The systems may include a PHANTOM® force-feedback device, for example, the PHANTOM® force-feedback device manufactured by SensAble Technologies, Inc., of Woburn, Mass., providing the operator with true 3D navigation and the ability to use his/her sense of touch to model quickly and accurately with virtual clay. This natural and direct way of working makes the system easy to learn, and users typically become productive within a few days. The operator can create original 3D models or use the systems with STL data from scanners or existing medical and dental software. CT/MRI scans that have been converted to STL data can also be used. Files can be exported for Rapid Prototyping (RP) or milling, and CAD/CAM.

Voxels are found herein to be advantageous for sculpting and carving virtual objects with organic shapes, such as teeth, bridges, implants, and the like. Other data representations may be used, for example, point clouds, polymeshes, NURBS surfaces, and others, in addition to, or instead of, voxel representation. A combination of voxel representation with one or more other types of data representation may also be used, for example, such that the benefit of voxel representation in sculpting and carving can be achieved, while the benefit of another data representation (e.g., NURBS curve for representing the preparation line) may be additionally achieved.

In addition to its use for modeling dental restorations in the integrated systems described herein, the haptic, digital modeling system can be used in dental training or other simulation scenarios, as well.

Also, in certain embodiments, the invention provides a rapid prototyping device and/or desk-top mill, suitable for use in an integrated dental restoration system for patient evaluation, restoration design, and fabrication all in one location, or for remote fabrication and/or design in an offsite dental lab. In certain embodiments, the invention provides a method for restorative dentistry utilizing an operator's sense of touch (via haptics) for interacting with a computer system, and including the steps of scanning a patient's situation, modeling a prosthetic device (e.g., tooth, teeth, bridge, partial, or the like), and producing the actual device via additive manufacturing or milling.

The headers below are provided for ease of reading and are not meant to limit the description of elements of the invention.

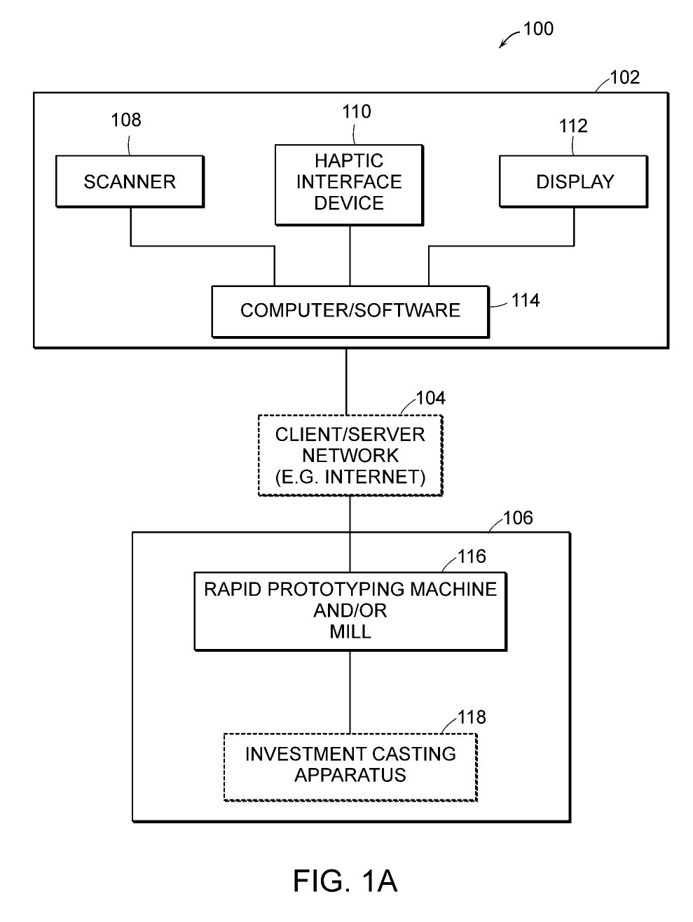

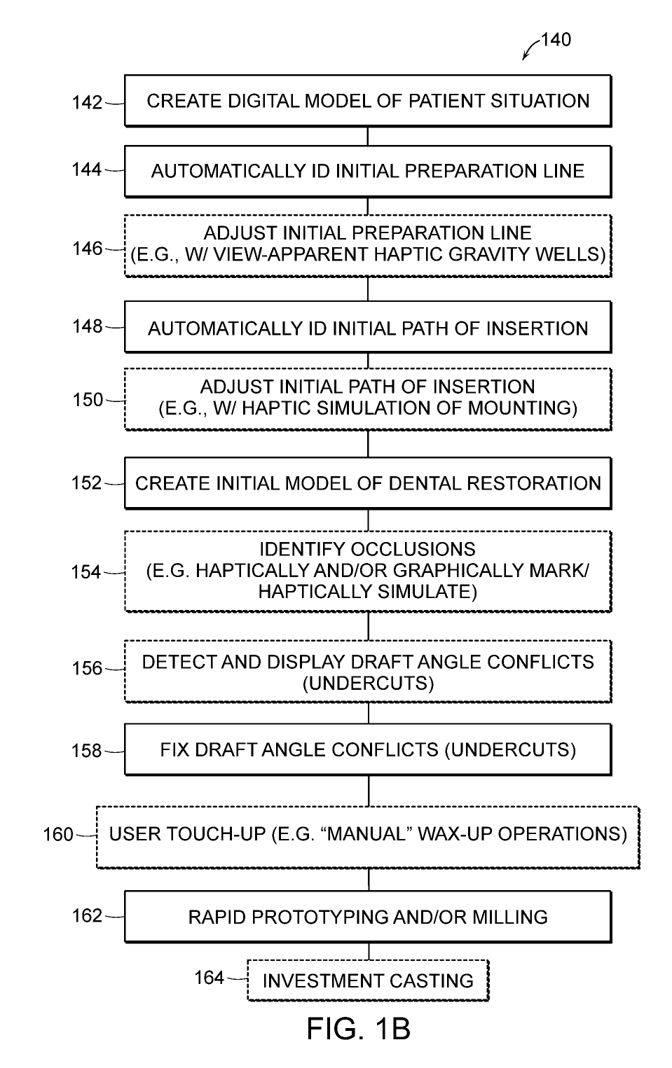

FIG. 1A is a block diagram 100 showing elements of a system for the haptic, digital design and fabrication of dental restorations. These elements are introduced here and are described in more detail elsewhere herein. In the block diagrams of FIGS. 1A and 1B, dotted lines indicate the element or feature is optional, but may be advantageously included for particular applications. The system of FIG. 1A includes a scanner 108, a haptic interface device 110, and a display 112, in communication with a computer 114 upon which system software 114 runs. In certain embodiments, the elements in block 102 are associated with the acquisition of data regarding the patient situation and design of the dental restoration adapted to the scanned patient situation. The elements in block 102 may be located, for example, at a dentist's office, and output data may be fed through a client/server network and/or the internet 104 to a subsystem 106 for fabrication of the designed dental restoration. The elements of subsystem 106 may be on site at the dentist's office, or may be offsite at a dental lab, for example. The fabrication elements include a rapid prototyping machine and/or mill, and may optionally include an investment casting apparatus (e.g., for fabrication of partials or other complex dental restorations).

FIG. 1B is a flow chart 140 showing steps in methods for the haptic, digital design and fabrication of dental restorations, according to an illustrative embodiment of the invention. Such methods advantageously use elements of the system shown in FIG. 1A. Step 142 is the creation of a digital computer model of a patient situation, for example, using an intraoral scanner and/or using a scan of an impression of the patient situation. In step 144, an initial preparation (margin) line is automatically identified, for example, using the algorithms described elsewhere herein. Step 146 offers the ability of a user to adjust the initial preparation line, advantageously using view-apparent haptic gravity wells. In step 148, an initial path of insertion is automatically identified. This initial path of insertion may be adjusted in step 150, for example, using haptic simulation of the mounting process. For example, the user may use the haptic interface device to “feel” how the dental restoration will be inserted onto the tooth/stub. The path of insertion initially determined automatically by computer may be adjusted by the user to avoid tender areas and/or to facilitate the best fit.

In step 152 of the method of FIG. 1B, an initial model of the dental restoration is automatically created in accordance with the digital model of the patient situation. The method may include identification of occlusions (step 154) and may haptically and/or graphically mark such occlusions. The haptic interface device may also be used to haptically simulate movement of the mouth to allow a user to “feel” or “sense” the effect of occlusions. In step 156, the method involves detecting and displaying draft angle conflicts (e.g., undercuts), which should be eliminated to allow proper fit of the dental restoration. The undercuts may be displayed graphically and/or haptically. Step 158 is the fixing (e.g., elimination) of draft angle conflicts. Step 160 allows for user touch-up of the modeled dental restoration; for example, the user may perform “manual” wax-up operations to eliminate any artifacts or create a more realistic-looking restoration.

The output of the modified dental restoration model is transmitted to a rapid prototyping and/or milling machine in step 162 for fabrication of the dental restoration, and investment casting may be performed in step 164, depending on the kind of dental restoration being fabricated. The fabricated dental restoration can then be fitted in the mouth of the patient.

### Scanner

Previous scanners for dental purposes have used single light sources and single image sensors to create three-dimensional descriptions. The single-exposure scanners require operators to move the scanning apparatus and/or the dental structure being scanned and to combine the resulting 3D descriptions into a composite description. Such constraints limit accuracy, reliability, speed, and the ability to scan negative impressions.

The scanner uses multiple light sources and multiple image sensors to eliminate the need to make multiple exposures and combine them algorithmically into a single composite description. Further, the elimination of multiple exposures eliminates the need to move the scanning apparatus and/or the dental structure being scanned. The elimination of these constraints improves the accuracy, reliability and speed of operation of the scanning process as well as the ability to scan negative impressions. Furthermore, the scanner has no moving parts, thereby improving accuracy and reliability of operation. The scanner makes use of multiple triangulation angles, improving accuracy, and multiple frequencies among light sources, with multiple sensors specific/sensitive to those light frequencies, improving reliability of results. The scanner also provides greater spatial coverage of dental structures using single exposures, improving accuracy and reliability.

In certain embodiments, the scanner works by positioning the scanning apparatus directly in the mouth of the patient (in the case of an intra-oral scanner) or inside a light-tight desk-top box together with an impression of the dental structure of interest (e.g. molded impression). The relative positions and orientations of the light sources and imaging sensors are known and are fixed. The 3D coordinates of points illuminated by the light sources can then be computed by triangulation. The accuracy of these computations depends on the resolution of the imaging sensor. Given finite resolution, there will be round-off error. The purpose of using multiple light sources and imaging sensors is to minimize the effects of round-off error by providing multiple 3D coordinates for illuminated points. The purpose of keeping the spatial relationships between light sources and imaging sensors fixed) by eliminating moving parts) is to minimize the error in interpolating the multiple 3D coordinates.

Using multiple light sources and imaging sensors also minimizes the amount of movement of the apparatus and/or the dental structure being scanned when scanning larger structures. This in turn minimizes blending or stitching 3D structures together, a process that introduces round-off errors. Using multiple light sources and imaging sensors also allows cavity depths to be more easily measured, because more 3D points are “visible” to (can be detected by) one or more sources and sensors.

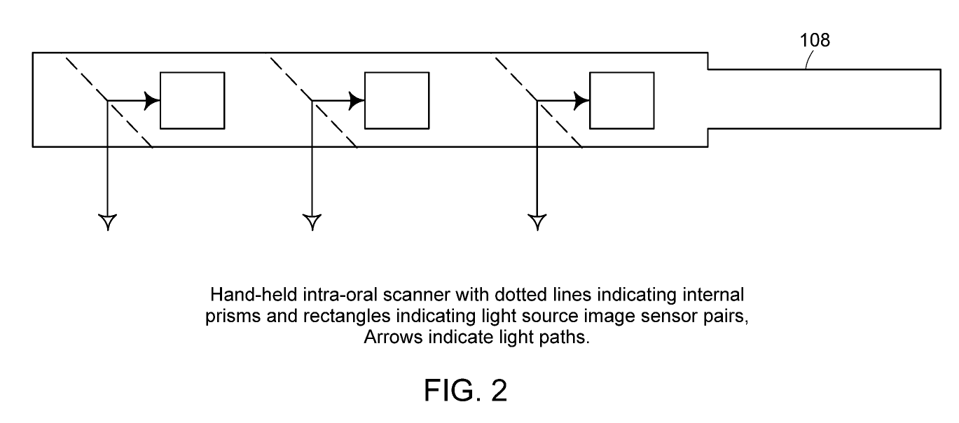

FIG. 2 is a diagram 200 of an illustrative hand-held intra-oral scanner 108 with multiple CCDs. The dashed lines 202 indicate internal prisms, the rectangles 204 indicate light source/image sensor pairs, and the arrows indicate light paths. When scanning using the intra-oral scanner, or alternatively, when scanning a dental impression, the system features the use of haptics to allow an operator to physically sense a contact point (or points) corresponding to the scanned impression, or the patient's situation (e.g. mouth tissue), through a force feedback interface, for use in registration of scan inputs. The haptic device encodes data identifying the location of the device in 3D Cartesian coordinate space. Thus, the location of the device (corresponding to the contact point(s) of the scanned object) is known, and as an operator senses that contact point, he/she can click a stylus button to let the system know to capture that location which can later serve as one or more registration points for scans made relative to that/those contact point(s).

In one embodiment, the scanner creates a virtual representation of an impression of the patient's situation (e.g., mouth tissue, teeth, gums, fillings, appliances, etc.). The impression may be a hardened gel impression obtained via known methods. The scan of the impression is a scan of a negative. The scanner described herein allows for avoidance of specularities and occluded surfaces by scanning an impression of the patient's teeth and gums. Use of speckled or patterned matter in the impression material may serve as potential reference markers in tracking and scanning. Color frequency encoding may be used to identify potential reference points in scanning and tracking. As described above, it is possible to identify multiple marker points within the impression to aid convergence of the scanning algorithms in constructing a 3D model of the patient's situation. Impressions reveal specularities with which to deal. Since an impression is a free standing object, it can be easily moved around for better scanning. The use of impressions of multiple colors can provide surface information to aid in determining surface points.

In another embodiment, the scanner creates a virtual representation of a directly-scanned patient situation (e.g., mouth tissue, teeth, gums, fillings, appliances, etc.). The scan of the patient situation is a scan of a positive. Here, DPL technology is used to illuminate grid patterns, optionally employing multiple colors to aid in the construction of 3D models. Color photographs of the patient situation may be used to assist in the construction of the 3D models and later mapping of these images onto the 3D models using a u-v mapping technology.

One, two, three, or more of the following may be used for registration of the scanning results for determination of an optimal 3D model of the patient's situation: structured light scans, cone beam data, photographs, x-rays, CT, MRI, voxel data, and STL data. In certain embodiments, low cost CCD sensors and light (single or multiple frequency) sources are simultaneously used to provide automatic registration and to eliminate any moving parts. In certain embodiments, a combination of parallax and triangulation methods are used to converge an optimal 3D model of the patient situation.

The following is a description of triangulation. If we take a plane of light with the equation Ax+By+Cz+D=0 and project it onto an object in 3D space, the projection of that plane onto the object surface will be a line whose shape is distorted by the object surface. If we have an image plane whose location and orientation are known with respect to the plane of light), we can choose a point (x′,y′) along the line as it appears in the image plane and compute its coordinates in 3D space as follows:

z=−D*f/(Ax′+By′+Cf) (1)

x=x′*z/f (2)

y=y′*z/f (3)

where f is the focal length associated with the imaging sensor.

For example, assume the viewer is located on the Z-axis at z=1 and the image plane is located in the X-Y plane at the origin (in 3D space) and the viewer is looking down the −Z axis. If we place the plane of light at say, z=−10, then A=B=0, C=1 and D=10. If we have the plane intersecting a sphere of radius 10 centered at z=−10 and let f=1, then the formulas above will give a depth of −10 for any point on the circle in the image plane representing the intersection of the plane of light with the sphere. The (x,y) coordinates of the points on the sphere corresponding to points on the circle of radius 1 centered in the image plane will lie on a circle of radius −10 in the plane z=−10.

### Haptic Interface Device

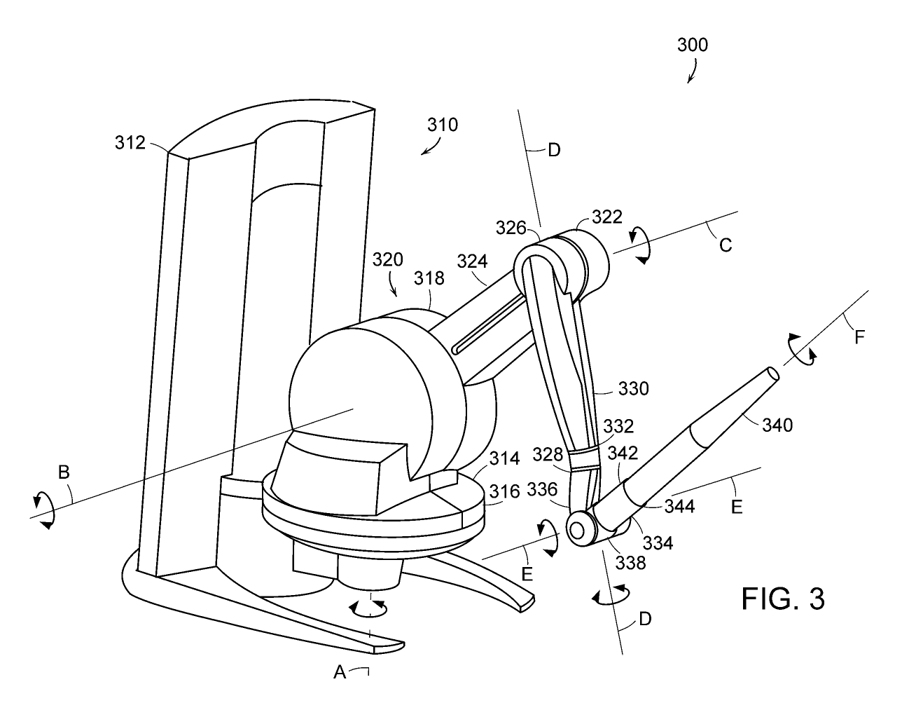

FIG. 3 is a schematic perspective view 300 of an exemplary six degree of freedom force reflecting haptic interface 310 that can be used in accordance with one embodiment of the invention. The interface 310 can be used by a user to provide input to a device, such as a computer, and can be used to provide force feedback from the computer to the user. The six degrees of freedom of interface 310 are independent.

The interface 310 includes a housing 312 defining a reference ground, six joints or articulations, and six structural elements. A first powered tracked rotary element 314 is supported by the housing 312 to define a first articulation 316 with an axis “A” having a substantially vertical orientation. A second powered tracked rotary element 318 is mounted thereon to define a second articulation 320 with an axis “B” having a substantially perpendicular orientation relative to the first axis, A. A third powered tracked rotary element 322 is mounted on a generally outwardly radially disposed extension 324 of the second element 318 to define a third articulation 326 having an axis “C” which is substantially parallel to the second axis, B. A fourth free rotary element 328 is mounted on a generally outwardly radially disposed extension 330 of the third element 322 to define a fourth articulation 332 having an axis “D” which is substantially perpendicular to the third axis, C. A fifth free rotary element 334 is mounted on a generally outwardly radially disposed extension 336 of the fourth element 328 to define a fifth articulation 338 having an axis “E” which is substantially perpendicular to the fourth axis, D. Lastly, a sixth free rotary user connection element 340 in the form of a stylus configured to be grasped by a user is mounted on a generally outwardly radially disposed extension 342 of the fifth element 334 to define a sixth articulation 344 having an axis “F” which is substantially perpendicular to the fifth axis, E. The haptic interface of FIG. 3 is fully described in commonly-owned U.S. Pat. No. 6,417,638, issued on Jul. 9, 2002, which is incorporated by reference herein in its entirety. Those familiar with the haptic arts will recognize that there are many different haptic interfaces that convert the motion of an object under the control of a user to electrical signals, many different haptic interfaces that convert force signals generated in a computer to mechanical forces that can be experienced by a user, and haptic interfaces that accomplish both results.

The computer 114 in FIG. 1A can be a general purpose computer, such as a commercially available personal computer that includes a CPU, one or more memories, one or more storage media, one or more output devices, such as a display 112, and one or more input devices, such as a keyboard. The computer operates using any commercially available operating system, such as any version of the Windows™ operating systems from Microsoft Corporation of Redmond, Wash., or the Linux™ operating system from Red Hat Software of Research Triangle Park, N.C. In some embodiments, a haptic device such as the interface 310 is present and is connected for communication with the computer 114, for example with wires. In other embodiments, the interconnection can be a wireless or an infrared interconnection. The interface 310 is available for use as an input device and/or an output device. The computer is programmed with software including commands that, when operating, direct the computer in the performance of the methods of the invention. Those of skill in the programming arts will recognize that some or all of the commands can be provided in the form of software, in the form of programmable hardware such as flash memory, ROM, or programmable gate arrays (PGAs), in the form of hard-wired circuitry, or in some combination of two or more of software, programmed hardware, or hard-wired circuitry. Commands that control the operation of a computer are often grouped into units that perform a particular action, such as receiving information, processing information or data, and providing information to a user. Such a unit can comprise any number of instructions, from a single command, such as a single machine language instruction, to a plurality of commands, such as a plurality of lines of code written in a higher level programming language such as C++. Such units of commands are referred to generally as modules, whether the commands include software, programmed hardware, hard-wired circuitry, or a combination thereof. The computer and/or the software includes modules that accept input from input devices, that provide output signals to output devices, and that maintain the orderly operation of the computer. In particular, the computer includes at least one data input module that accepts information from the interface 310 which is indicative of the state of the interface 310 and its motions. The computer also includes at least one module that renders images and text on the display 112. In alternative embodiments, the computer 114 is a laptop computer, a minicomputer, a mainframe computer, an embedded computer, or a handheld computer. The memory is any conventional memory such as, but not limited to, semiconductor memory, optical memory, or magnetic memory. The storage medium is any conventional machine-readable storage medium such as, but not limited to, floppy disk, hard disk, CD-ROM, and/or magnetic tape. The display 112 is any conventional display such as, but not limited to, a video monitor, a printer, a speaker, an alphanumeric display, and/or a force-feedback haptic interface device. The input device is any conventional input device such as, but not limited to, a keyboard, a mouse, a force-feedback haptic interface device, a touch screen, a microphone, and/or a remote control. The computer 114 can be a stand-alone computer or interconnected with at least one other computer by way of a network, for example, the client/server network 104 in FIG. 1A. This may be an internet connection.

### Model

In certain embodiments, the invention includes a haptic, digital modeling system, suitable for use in the integrated dental restoration system. The system is a touch-enabled modeling system that allows the operator to create complex, organic shapes faster and easier than with traditional CAD systems. The fact that the modeling system is haptic (e.g., provides meaningful force-feedback to an operator) allows for intuitive operation suitable for creating models of organic shapes, as needed for dental restorations.

The model provides for the identification of the patient's margin (prep) line using a combination of mathematic analysis of polygonal surface properties—for example, determining where sharp changes of tangency occur—and the operator's haptically enabled sense of touch to refine mathematical results into a final 3D closed curve.

The model also features automatic offset shelling from interior concavity (negative of the stump) surface of the prosthetic utilizing voxel data structures. This provides a modified surface which can be used to accommodate dental cement or bonding agents between the patient's actual stump and the interior surface of the prosthetic device.

The model also features automatic offset shelling from the exterior surface of the prosthetic utilizing voxel data structures. This provides a modified surface which can be used to compensate for shrinkage of the actual prosthetic device during processing or to accommodate additional surface treatments. The shelling can be used to either increase or decrease the volume contained by the exterior surfaces.

The model also features a method of detecting collisions between objects in order to sense the fit of the virtual or actual prosthetic device and to make adjustments for occlusions with adjacent and opposing teeth.

In certain embodiments, the system uses scanning and/or motion tracking to capture general and specific articulation of patient movement—e.g., grinding, chewing, clenching—for later use in testing the fit of restorative work. In effect, this can be described as inverse kinematics in computer animation. The haptic functionalization of the model allows further interactivity, allowing the user to “feel” the fit of restorative work during patient movement.

In certain embodiments, the model provides a method for quality control of the physical prosthetic employing a scan of final manufactured prosthetic with haptically enabled sensing of surface areas. The method features color coding of surface areas of particular interest to the dentist along with the ability to haptically mark areas on a 3D model of the scan data for reference by the dentist in final modifications to the prosthetic.

In certain embodiments, methods of the invention include creating and employing a standard library of tooth models in voxel data form whereby the standard model can be imported upon request and instantly made available for automatic or manual alteration. The library can take varying degrees of customization—from creating patient specific models of all teeth prior to any need to restorative work to utilizing standard shapes for each tooth based on patient specific parameters.

Haptics allows intuitive, interactive checking of alignment of implants and implant bars, for example. Multiple complex draft angle techniques may be used to verify insertion and removal will be possible without undue stress. For example, if four implants are used in a restoration, the first and fourth cannot be angled away from each other because the implant bar will not be able to slide on and off easily. The model automatically detects draft angle and shows conflicts in color.

Haptics may also be used in checking surgical guides, for example, in the alignment of implants and bars. Haptics can be used to help set drilling angles and/or to produce guide fixtures for use in surgical procedures.

The model provides for the creation and utilization of a set of haptic/voxel-based wax up-like modeling tools. The model features virtual wax up methods and techniques for dental restoration work, for example, with veneers.

Haptic methods aid in the detection of potential prep line or tooth shape problems at either the virtual modeling stage or the post manufacture scan of the physical device. Haptic functionality of the modeling system allows the operator to feel what can't necessarily be seen—feeling a feature virtually before committing to a modification can help the operator conduct the operation more smoothly, as in pre-operative planning. The operator can detect occlusions, explore constraints in maneuvering the prosthetic into place, and can detect areas that might catch food or present problems in flossing, all by “feeling” around the model haptically, before the restoration is actually made.

The model also provides abstract interfaces for a variety of imported and exported dental data and control signal types. Developing a digital dentistry system with the abstract interfaces to data and control signals of various subsystems promotes evolution of technical solutions. The model may include general data translators and interfaces that can accommodate new component modules by writing to or from a generalized format with metadata.

In restorative work involving implants, it important not to over stress the gum tissue as it can be damaged or killed. Implants typically involve a metal post or sprue that is mounted into the jaw bone; a metal abutment that is attached to the top of the post; and a prosthetic tooth that is joined to the abutment. The area where post, abutment, and restorative prosthetic come together involves working at or just below the gingival line (gum line). Modeling different materials and associating with them certain properties (e.g. elasticity) offers an ability for the dentist or orthodontist to plan and practice the operation in a virtual workspace—testing the limits of the patient tissues prior to actual operation. The use of multiple densities and collision detection may be involved as well.

### Rapid Prototyping Machine/Milling Machine

The dental restoration is fabricated with a rapid prototyping machine and/or a milling machine (mill), for example, a 3-D printer or an integrated, desk-top mill. The system may include software that converts the file format of the modeled restoration into a format used by the rapid prototyping machine and/or desk-top mill, if necessary. For example, STL file output from the model may be converted to a CNC file for use as input by a desk-top mill.

Methods to enhance the production stage (e.g., milling or rapid prototyping) are provided. For example, the model provides the ability to compensate for material shrinkage by utilization of its shelling techniques, described herein. Also, the system can provide colored voxels in the 3D models for use as input by the additive manufacturing processes (e.g., rapid prototyping) capable of producing varying colors and translucency in the materials used to create the prosthetics.

The milling machine is sized for dental applications. Exemplary milling machines are those used in the CEREC system (Sirona), or any desk-top mill adapted for dental applications, for example, CNC milling machines manufactured by Delft Spline Systems, Taig Tools, Able Engraving Machines, Minitech Machinery Corporation, Roland, and Knuth.

### Integrated System

In certain embodiments, the system includes a haptically-enabled client/server networked environment to accommodate workflows within a single site dental practice or between multiple practices or between a practice and a dental lab. Through haptics, users in the network are able to add their sense of touch to understanding and communicating about the workflow, its problems, and its outputs. There may be distributed processing of haptic interaction.

An illustrative embodiment features a haptically enabled 3D application interface providing ease of use for the operator. For example, an illustrative system provides a single button activation of basic steps in the process, for example, setup, scan, model (e.g., margin and design), and mill. A setup mode brings up the patient record and full model of the patient's teeth. A scan mode captures and imports data from the scanning stage. A model mode identifies and fixes the prep line; creates an initial prosthetic model using a standard database of tooth types, automatically altered to conform to the prep line and scan data of the patient; and uses haptics and the underlying voxel data to interactively modify this model employing visual and haptic cues such as color coding and haptic guides (e.g., gravity wells), for example, using domain constrained modeling. A mill mode sends the final 3D model to either milling or additive manufacture processing. Haptics and voxels are used to disambiguate positions in 3D space, e.g. by providing feedback to the operator while he/she is locating a point in 3D assisted by his/her sense of touch. The representation and use of multiple densities in a voxel-based model to mimic the feel of different materials—both organic and manufactured—allows the operator to sense the difference between soft tissue, bone, enamel, pulp, and synthetic materials.

The haptic and voxel-based scanning and modeling techniques allow use of the system to prepare complex restorations such as anterior veneers, multi-unit bridges, and custom implant abutments and implant bars. Unlike posterior teeth, anterior or front teeth are more visible and require a higher degree of aesthetic shaping. In current approaches, teeth are prepared (reduced) to accept a new veneer; an impression is made of the prepped situation; a positive plaster cast is made from the impression; a manual wax up based on the positive is made; this wax up is either used in a casting to produce the veneer or is scanned to provide 3D data which in turn is fed to a milling procedure to produce the veneer; and the veneers are then bonded to the patient's prepped teeth. In an illustrative system presented herein, the wax up stage is replaced by scanning either the impression or the actual prepped teeth to generate 3D scan data; haptically-enabled 3D modeling of the veneer replaces the former wax up stage; the model output is fed to a milling machine and/or rapid prototyping machine, which produces the veneer; and the veneers are then bonded to the patient's teeth.

In certain embodiments, the system provides for the creation of partial frameworks for removable dentures. A partial framework is created based on a model of the gums and teeth. The model situation (gum and teeth) are then used to model the framework that will sit atop the gum and be anchored to adjacent teeth. The model is fed as input to a rapid prototyping (or additive manufacturing) machine, and a physical wax model is created. The wax model is then used in investment casting (e.g., in a “lost wax” cast) where metal is poured into the wax cast, thereby melting the wax and replacing the cavity it formed with metal. Thus, the metal partial framework is produced.

### Automatic Preparation (Margin) Line Extraction and Editing

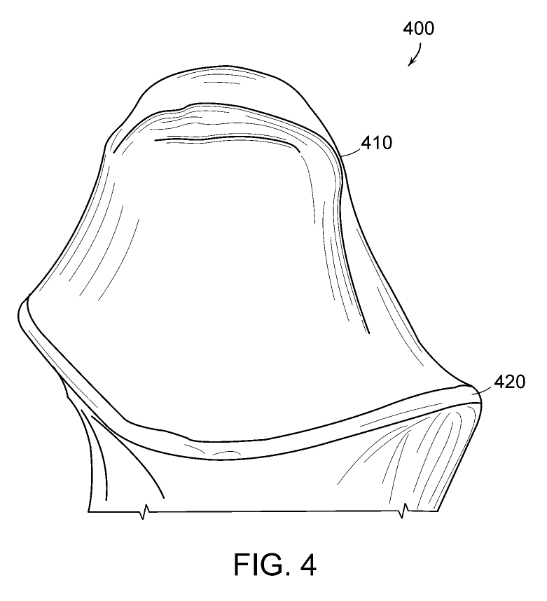

An important geometrical feature in a coping is the margin line, also called the preparation line. This is the line where the coping meets the prepared tooth. FIG. 4 shows a polymesh format representation 400 of a scanned tooth preparation. In FIG. 4, the red line 420 illustrates the margin line (preparation line), and the purple area 410 represents the scanned tooth preparation in polymesh format. The scanned tooth may also be represented in a variety of other formats, including a rasterized voxel model generated from the original polymesh format, a NURBS surface fit to the original polymesh format, etc.

The margin line 420 rides along what manifests itself as a ridge in the prepared tooth (and thus the scanned model of the same prepared tooth). A process called “ditching” is used by the dental lab technician to modify the plaster model before scanning to bring the contour of the margin line into relief. In general, but not always, the margin line represents a closed loop strip of geometry where there is a significant surface curvature difference from the rest of the model—generally, the margin line rides on the locus of the smallest radius of curvature of the geometry within one to two millimeters of the gingiva.

In one implementation, a NURBS curve approximating the margin line is generated from the original scan data in triangular mesh format by the following mechanism:
User clicks once on a point that lies along the margin or preparation line. This point serves as a first guess seed point for the rest of the algorithm.
Optionally, generate a plane that is perpendicular to the path of insertion and which passes through this seed point. This plane and the seed point may be used as a datum for approximate placement of the margin line.
Optionally, generate two more planes at a predetermined distance above and below this seed point. These two planes will be used to select a portion of the scanned triangular mesh to do the automatic margin line detection on. Alternatively, the entire scanned data may be selected and used for margin line detection.
For each vertex and facet in the selected portion of the scan data in polymesh format, compute a local curvature metric based on a composite score that can take into account a combination of the following curvature metrics.
   The angular differences between all the facets that meet at each vertex—a typical valency, or number of triangular facet neighbors for a vertex in a triangular mesh is six, however extraordinary valence may occur in some proportion of vertices where the number of facet neighbors may be greater or smaller than six.
   The angular differences between triangular facets across each of its three edges.
Starting at the seed point, and working within the selected region of the scanned triangular mesh data, iterate through all the vertices and/or facets in the scan data, and identify a contiguous strip of triangular mesh where the radius of curvature either falls below a predetermined threshold, or is relatively lower than the rest of the model, or both.
Generate a contiguous loop of sample points by selecting either the centroid of each triangular facet if using a facet-based local curvature metric, or the vertices if using a vertex-based local curvature metric, or the midpoints of edges that lie mostly perpendicular to the direction of the margin line.
Fit a NURBS curve to these sample points using a least squares method with an adaptive knot vector where knot and control point placement are determined dynamically based on the local separation between the sample points. Optionally, fit this curve to a tolerance using an iterative, globally optimized approach.
Relax the NURBS curve along the facet surface of the scanned triangular mesh data to result in a smoother outcome.
Optionally, project a tessellation of this curve to the facets and generate a polyline with line segments that lie directly on facets in the original scanned triangular mesh data.

The margin line may be fit to a digital model of the prepared tooth in a variety of ways, including:
A NURBS curve with a variable, adaptive knot vector which is fit via a least squares mechanism to a closed series of unevenly spaced sample points that lie upon the scanned polymesh model of the prepared tooth. The number of control points can be user determined or algorithm driven.
A NURBS curve as described above, fit iteratively to a tolerance using a global optimization approach, where both the number of control points and the first guess control point locations are perturbed repeatedly to reduce the variation between the curve and the sample data, until the desired fit tolerance has been reached
A NURBS curve with a fixed, evenly spaced knot vector and a user or software determined number of control points, which is fit to substantially evenly spaced sample points on the polymesh scan data via a least squares mechanism,
A polyline composed of line segments that trace the margin line and traverse each facet in the scanned polymesh model,
Other curve or polyline representations that approximate the margin line curve.

### Haptically Enabled Editing of the Preparation/Margin Line

While the automatic margin line detection algorithm will generate a reasonable first guess for most typical margin lines, there are cases where the prepared tooth assumes an atypical geometry, or there is a defect in the impression or scanning process that results in a geometrical artifact. In this event, the user would need to adjust the automatically generated margin line.

The haptic dental restoration system described herein provides an intuitive method to edit and adjust the margin line via a haptically enabled “edit point” dragging mechanism. When complete, the margin line will present with a number of “edit points”, which are points along the curve that the user can click and drag with.

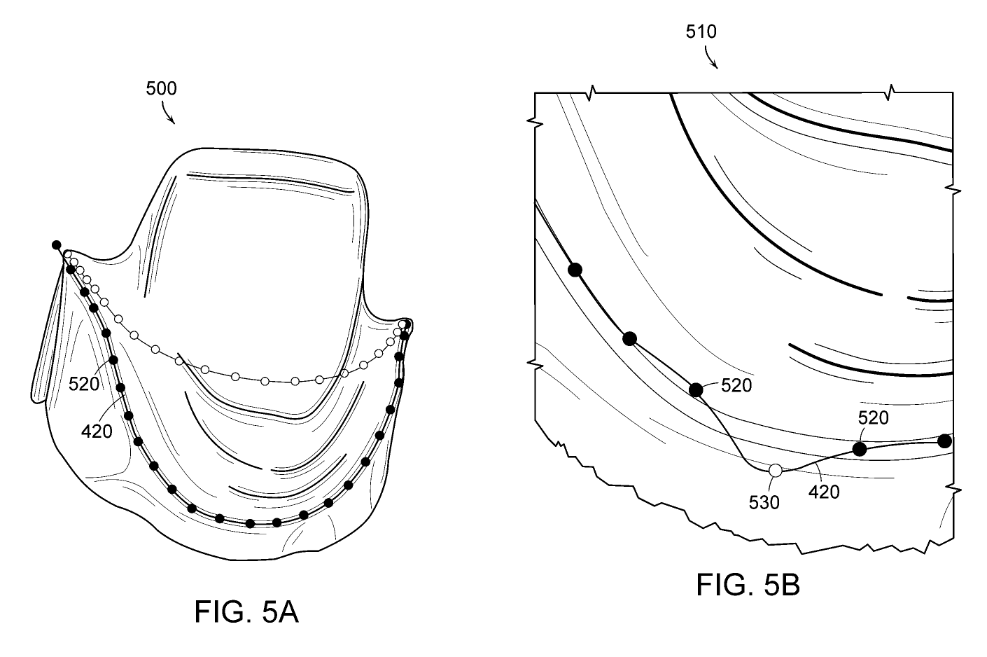

FIGS. 5A and 5B show representations (500, 510) of a scanned tooth preparation illustrating haptic enabled editing of a margin line using haptic edit points.

FIGS. 5A and 5B show edit points 520 along the margin line curve 420. Each edit point 520 on the margin line 420 presents itself as both a haptic gravity well and a graphical snap point. These haptic gravity wells work on a view apparent basis. When the haptic interface device (e.g., the PHANTOM™ device manufactured by SensAble Technologies, Inc., of Woburn, Mass.) is used to drive the cursor to hover over one of these edit points, the cursor will be snapped to the location of the edit point. If the user then presses the haptic device select button, that edit point can then be dragged and moved along the scanned data. FIG. 5B shows an edit point 530 which has been dragged downward along the surface of the prepared tooth. The haptic device presents the user with a sense of touch as though the user is feeling the scanned model with the tip of a pen.

The mechanism by which this view apparent selection and haptic sensation is described in detail in U.S. Pat. No. 6,671,651, issued on Dec. 30, 2003, and incorporated by reference herein in its entirety.

### Setting Path of Insertion and Fixing Undercuts

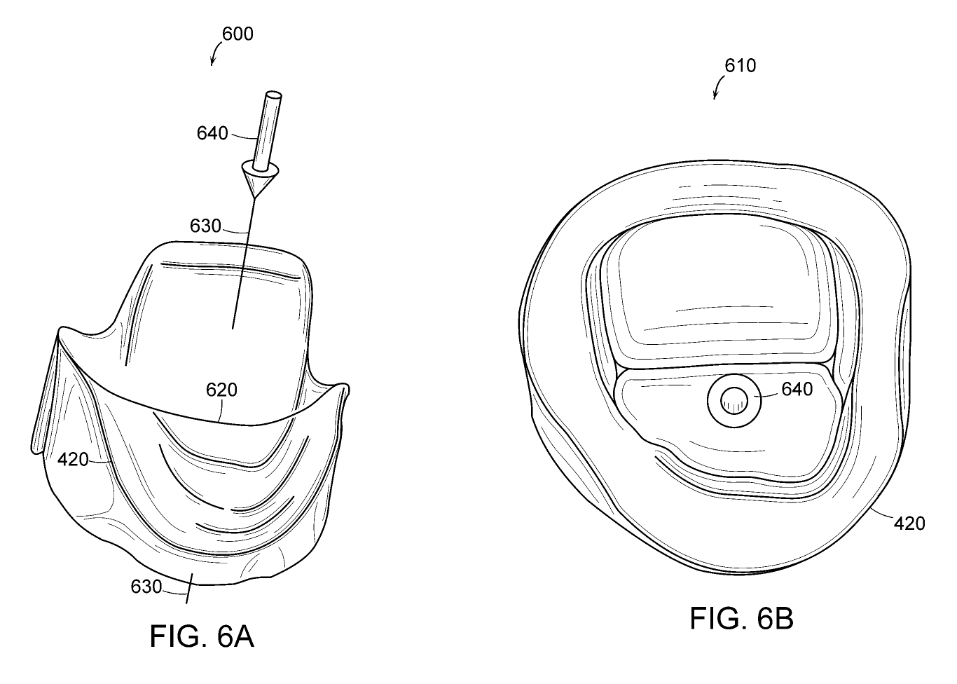

Once the margin line is generated, the next step in the generation of a coping or an abutment in a bridge framework is the selection of a path of insertion. FIGS. 6A and 6B show representations (600, 610) of a scanned tooth illustrating selection and modification of a path of insertion 630. A first guess for the path of insertion 630 is automatically derived from the scan direction for the prepared tooth.

The user may subsequently modify the path of insertion by viewing the scanned tooth preparation from the side (view 600) or from above (view 610), and haptically modifying the path of insertion until the user feels that the path by which the coping will be mounted to the prepared tooth is correctly determined. The path of insertion selection/modification tool is shown at 640 in FIGS. 6A and 6B. One or more guidelines may be displayed (620), relative to the path of insertion 630.

In general, when the path of insertion is correctly determined, the margin line 420 is visible in its entirety when the scanned tooth preparation is viewed along the direction of the path of insertion (see FIG. 6B). Once a path of insertion has been determined, the tooth preparation needs to be adjusted to fix any undercuts. Unaddressed undercuts will result in failure of the coping to fit, so it is very important that these are addressed prior to the generation of the coping geometry.

In the haptic dental restoration system described herein, an automatic mechanism is provided for fixing undercuts in copings via the following algorithm:
Given a path of insertion determined by the end user, rasterize the scanned tooth preparation in polymesh format into a high resolution 3D voxel volume. The 3D voxel volume is oriented such that the Z-axis of the voxel volume is aligned with the path of insertion, and the XY plane for each layer of voxels is orthogonal to the path of insertion.
   The resolution of the voxel volume is matched to the typical feature size of the undercuts (typically ranging from 0.025 um to 0.080 um).
   In one implementation, the voxel resolution is set at 0.070 um, which addresses the vast majority of surface undercuts with no discernable impact on fit.
   In another implementation, the voxel resolution is set substantially lower, to match the scanner resolution around 0.025 um, to capture all the details in the scanned data to the extent possible.
For each layer of voxels, starting from the top of the volume and working down towards the margin line, apply a height field based algorithm to identify voxels in each layer which would have violated a given draft angle (typically 0 degrees) based on occlusion by voxels in a previous, higher layer of voxels. The algorithm is further described in U.S. Pat. No. 7,149,596, issued on Dec. 12, 2006, and incorporated by reference herein in its entirety.
For each voxel that violates a given draft angle, execute either a cut or an add operation to eliminate undercuts.

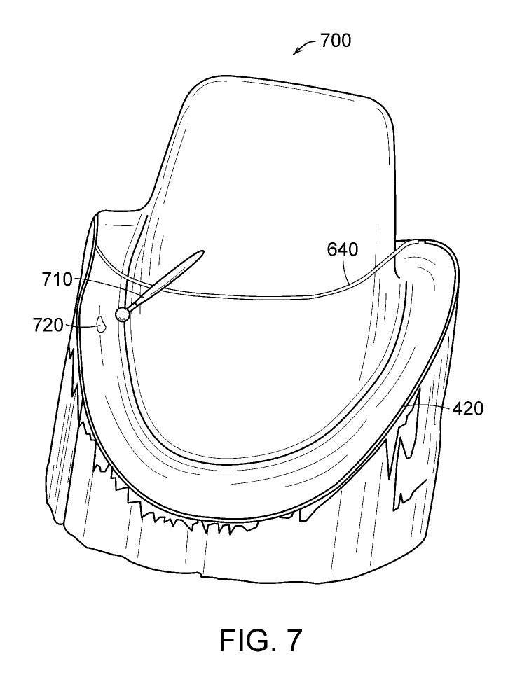

FIG. 7 is a representation 700 of a scanned tooth preparation and illustrates an undercut that was fixed via the automatic undercut fixing algorithm (see the blue dot 720 within the maroon model). The area of undercut 720 is fixed by addition of material to “fill in” the undercut region. A haptic/graphical user interface tool 710 can be used to facilitate this undercut fixing feature. As an optional step it can be determined if the chosen path of insertion will lead to the margin line being covered by added material, which would result in an invalid coping. This can be used to warn the user or prevent the operation.

Once the undercuts are fixed, the user has the option to perform additional hand wax-up operations to further touch up the model before the coping geometry is generated. This can be facilitated by a variety of interactive virtual wax modeling tools.

### Design and Fabrication of Partial Dental Frameworks Using a Haptic Dental Restoration System

The process of manufacturing partial denture frameworks has remained largely unchanged for the past 50 years or more. In general, the following eight steps are performed:

(1) an impression of the patient's situation is created in the Dentist office;
(2) the dental lab will make positive models of that impression from plaster;
(3) the dental lab will determine the “path of insertion” for the partial framework, and will modify one of the plaster models to block out undesirable undercuts with wax;
(4) a new copy of this model (the refractory model) is created from material that is intended to be used in the investment casting process;
(5) the partial framework is designed and created using wax and wax patterns, directly on this refractory model;
(6) the refractory model and wax are “sprued” and covered in additional investment material, and placed in an oven to “burn out” the wax pattern;
(7) metal is injected into the resultant mold, which creates the framework; and
(8) the mold is broken open to remove the metal framework, which is then finished in an autofinisher and/or by hand.

This procedure can be greatly simplified and improved using the haptic dental restoration system described herein. For example, in an illustrative embodiment, the following steps corresponding to the eight numbered steps above are performed using the haptic dental restoration system described herein, to fabricate a partial dental framework:

(1) an impression of the patient's situation may still be created. Alternatively, if an intra-oral scanner is used, the resultant scan file (in a triangular mesh format such as STL) is directly fed into the modeling system;
(2) if using an intra-oral scanner, no copies are required. If using a dental scanner, then the impression may either be scanned directly, or at least one plaster positive may be created from the impression and then scanned, and the resultant scan file (in a triangular mesh format such as STL) is directly fed into the modeling system;
(3) determining the “path of insertion” is done using software tools in the Dental modeling application which show the user the presence of undercuts and the amount of each undercut. The model is then digitally “blocked out”;
(4) there is no need for creating a physical refractory model, as this is represented in the modeling software;
(5) the partial framework is designed using virtual wax tools as well as tools specifically designed to aid in the speedy creation of certain features of partials. The resultant design is exported to an STL file and sent to the 3D printer;
(6) if the output of the 3D printer or mill is a material like metal or zirconia, then there is no need for investing the result; if the output is wax or a photopolymer type material, then the framework is “sprued” and cast in a fashion similar to the traditional wax design, but without the refractory model;
(7) unchanged; and
(8) unchanged.

A significant advantage of using the haptic digital system is that it does not require certain items needed in the traditional method (e.g., refractory model, casting. Also the traditional method is a destructive process, destroying the wax model and refractory model, so any changes to the design after casting need to be recreated from scratch. In the digital method, the digital design model can be modified and a new part printed or milled.

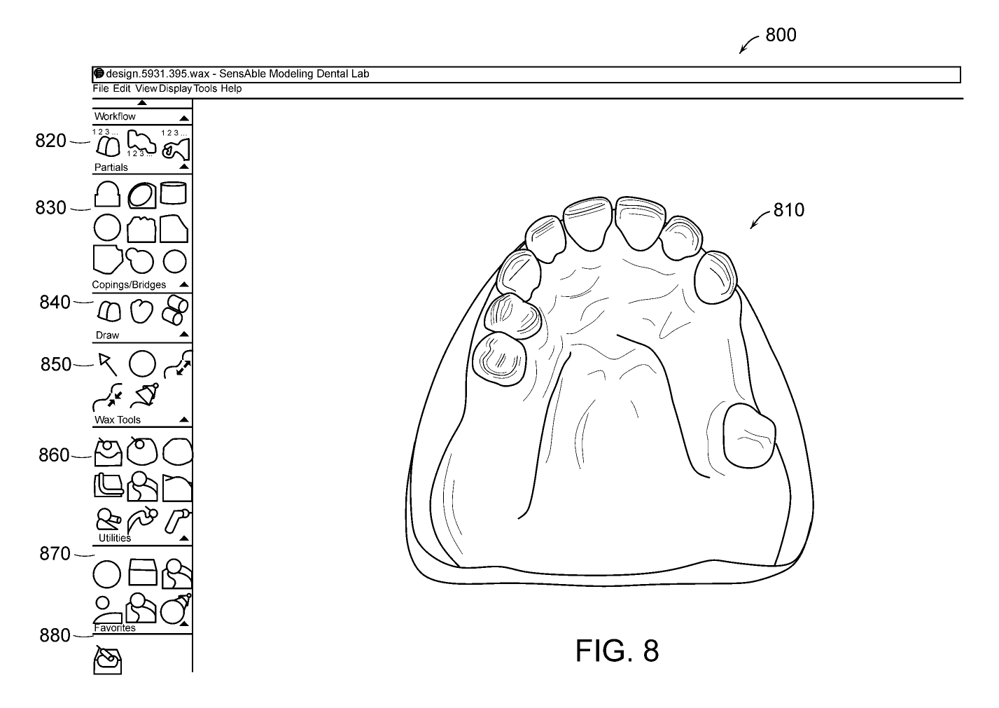

FIGS. 8-20 are screenshots demonstrating various features and applications of the system for haptic, digital design of dental restorations, described herein.

FIG. 8 is a screenshot 800 of modeling application software after importing the output of a digital dental scanner to form a model of a patient situation 810. The software allows intuitive interaction by a user. The icons 820-880 on the left of the screenshot 800 show features of the software that may be selected by the user. Item 820 allows the user to initiate steps in the workflow for the design and fabrication of various kinds of dental restorations. Items 830 and 840 show libraries of partials, copings, and bridges, that can be used in the design of the dental restoration. Item 850 represents drawing tools, item 860 represents wax tools, and item 870 represents utilities that can be used in the fabrication of the dental restoration using the software. Item 880 allows the user to store favorite or often-used tools on the workspace.

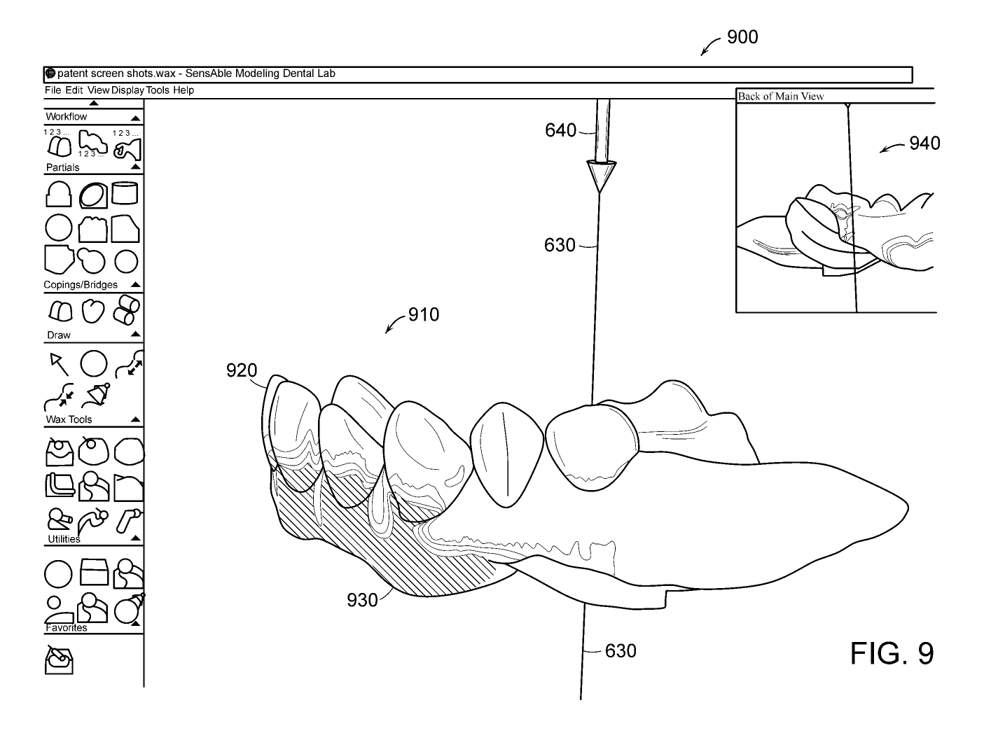

FIG. 9 is a screenshot 900 of a modeling application showing a digital tool 640 used to determine a path of insertion 630. The colors of the model 910 indicate the depth of undercut that is automatically detected. Blue areas 920 indicate no undercut, while red areas 930 indicate deep undercut. The software also features a second view 940, whereby the user can view the model 910 from another angle (e.g., the back).

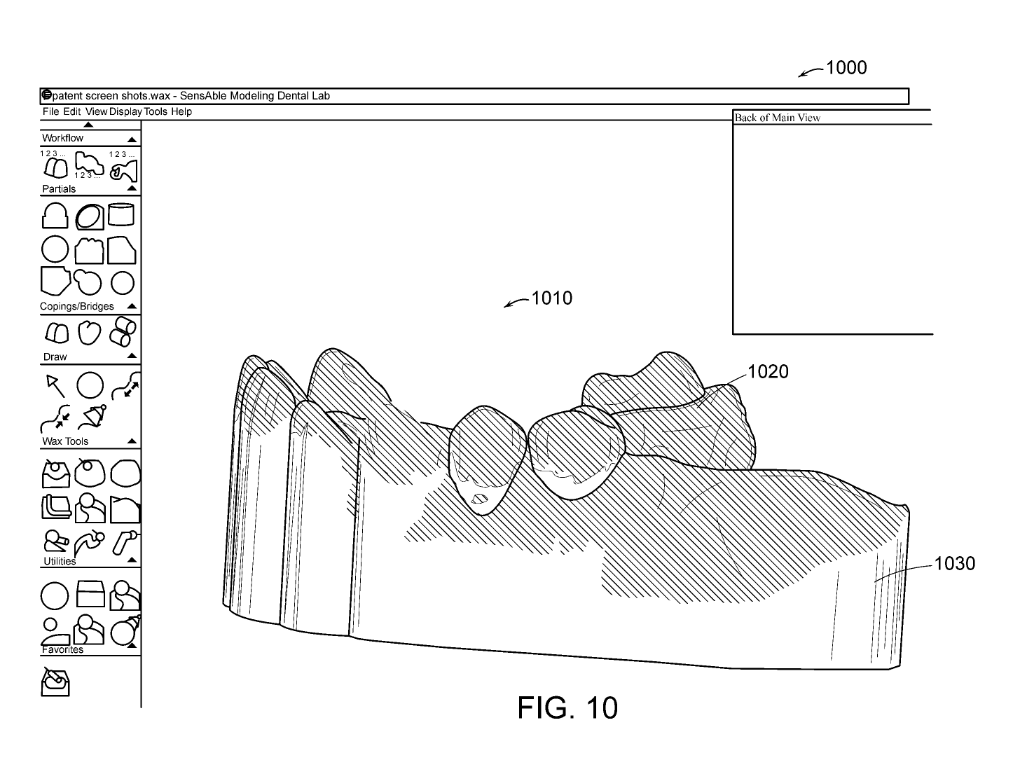

FIG. 10 is a screenshot 1000 of a modeling application showing an initial digital refractory model 1010 with undercuts automatically blocked out. At this point, voxel modeling tools can be used to modify blockout wax to expose desired undercuts. The automatically blocked-out undercuts are shown as tan wax (1030), and the initial digital refractory model is shown in maroon (1020).

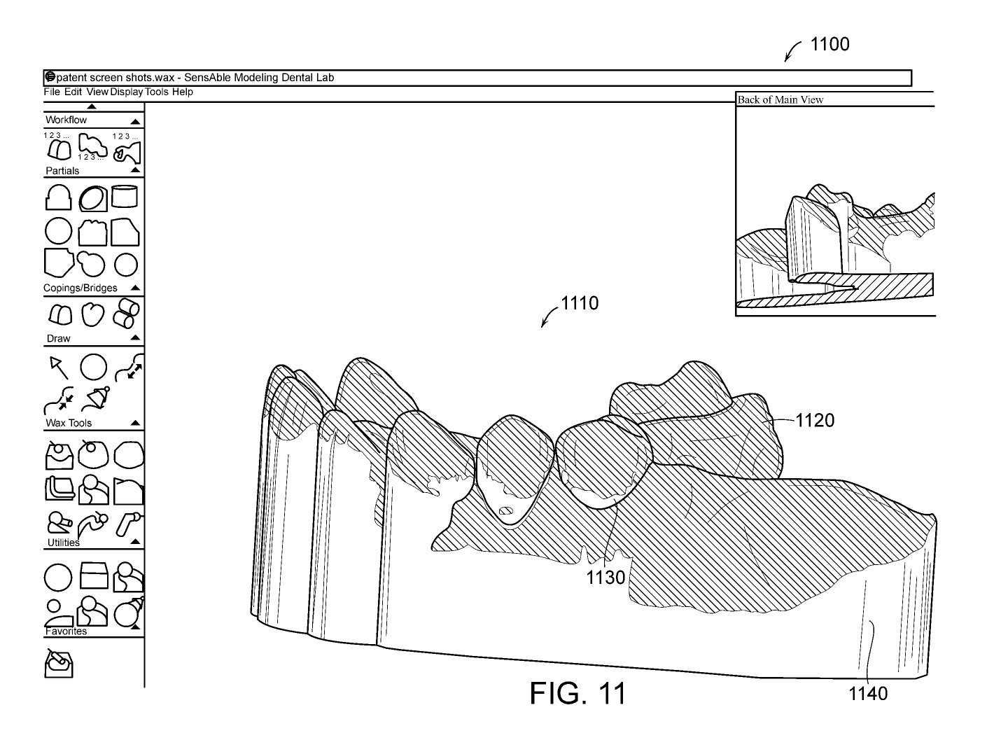

FIG. 11 is a screenshot 1100 of a modeling application showing the final digital refractory model, including blockout wax and highlighted undercuts. Added blockout wax is displayed as blue 1140, indicating it cannot be changed. Colors near the base of the tooth 1130 show where desirable undercut for clasp retention was exposed.

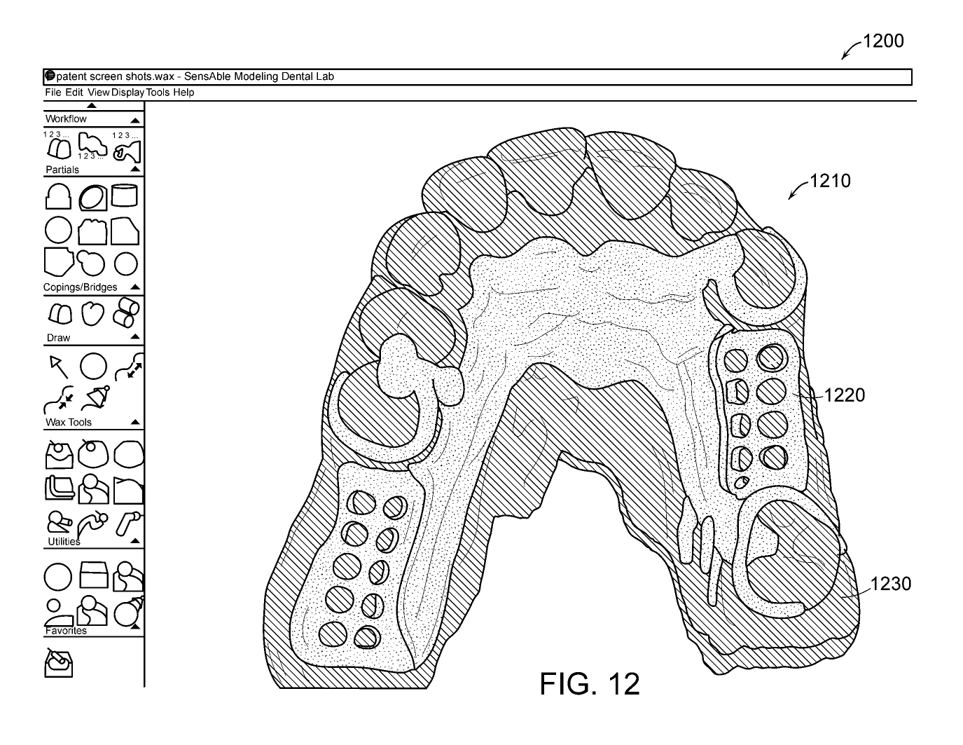

FIG. 12 is a screenshot 1200 of a modeling application showing a completed digital partial design. Digital wax (tan area—1220) has been applied to the digital refractory model (maroon area—1230).

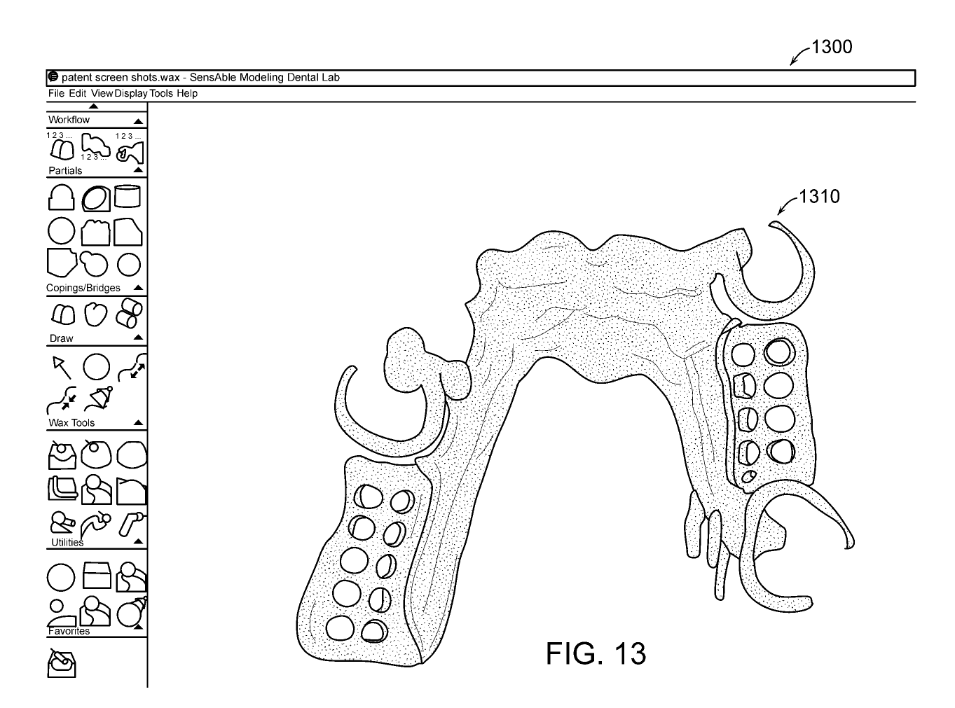

FIG. 13 is a screenshot 1300 of a modeling application showing a partial frame 1310, which may be sent to a 3-D printer and/or mill for fabrication. The refractory model has been automatically removed.

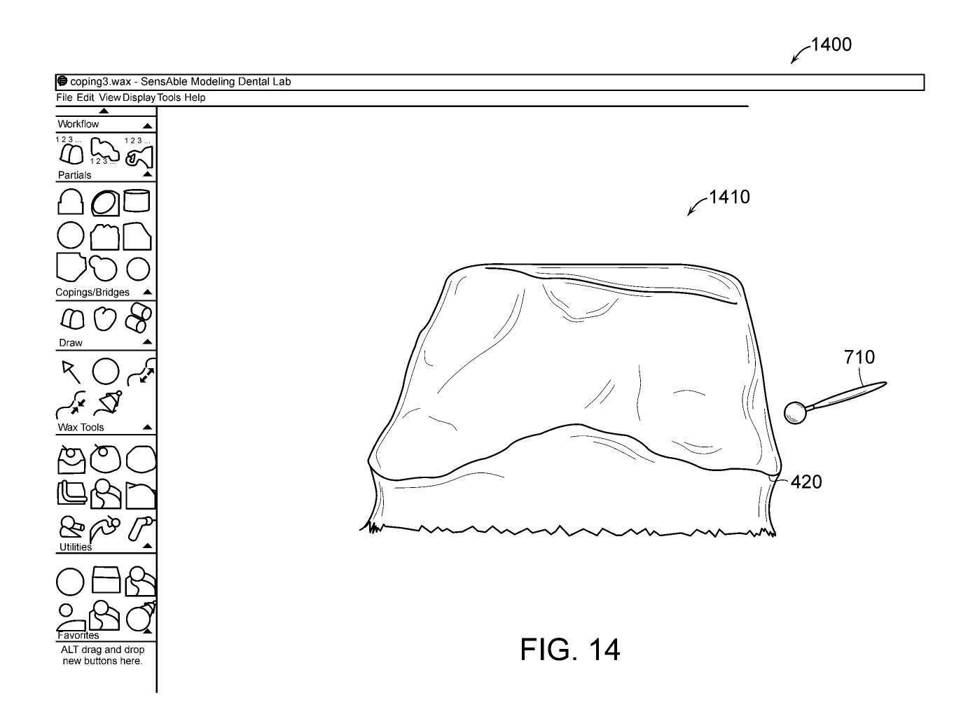

FIG. 14 is a screenshot 1400 of a modeling application showing a scan 1410 of a prepared stump for coping. The margin/preparation line 420 is automatically detected and can be modified using a haptic tool 710 with which a user can haptically “feel” the stump.

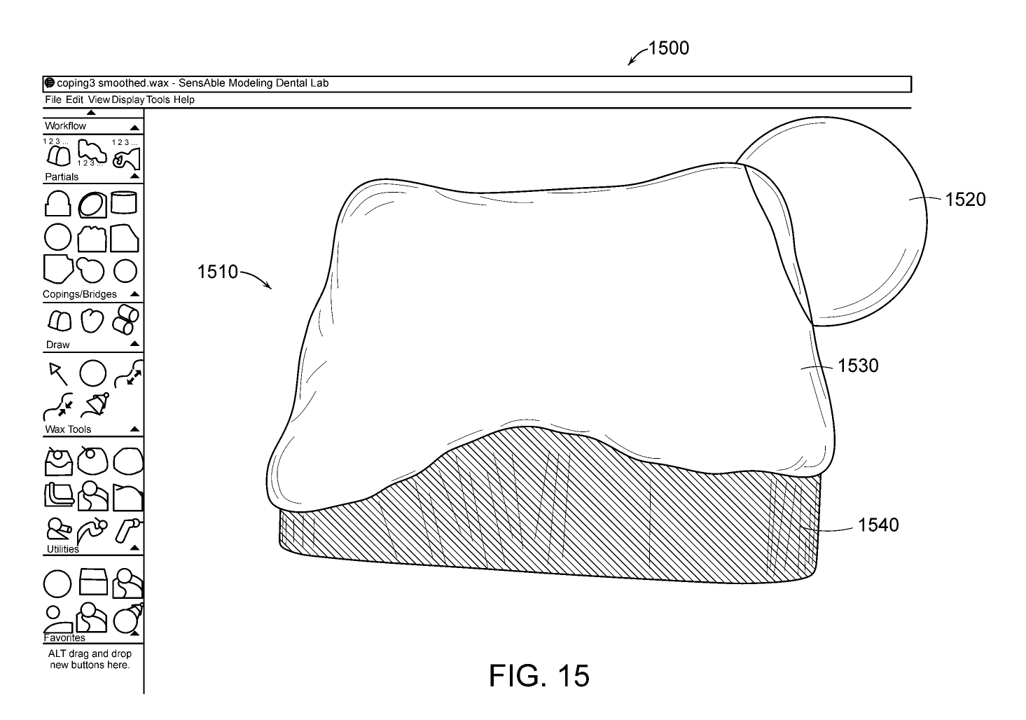

FIG. 15 is a screenshot 1500 of a modeling application showing a digital wax version of the coping 1530 (tan) with a refractory model of the stump 1540 (maroon). The top of the wax has been modified with a haptic/voxel tug tool 1520 to add material and give a more anatomical look.

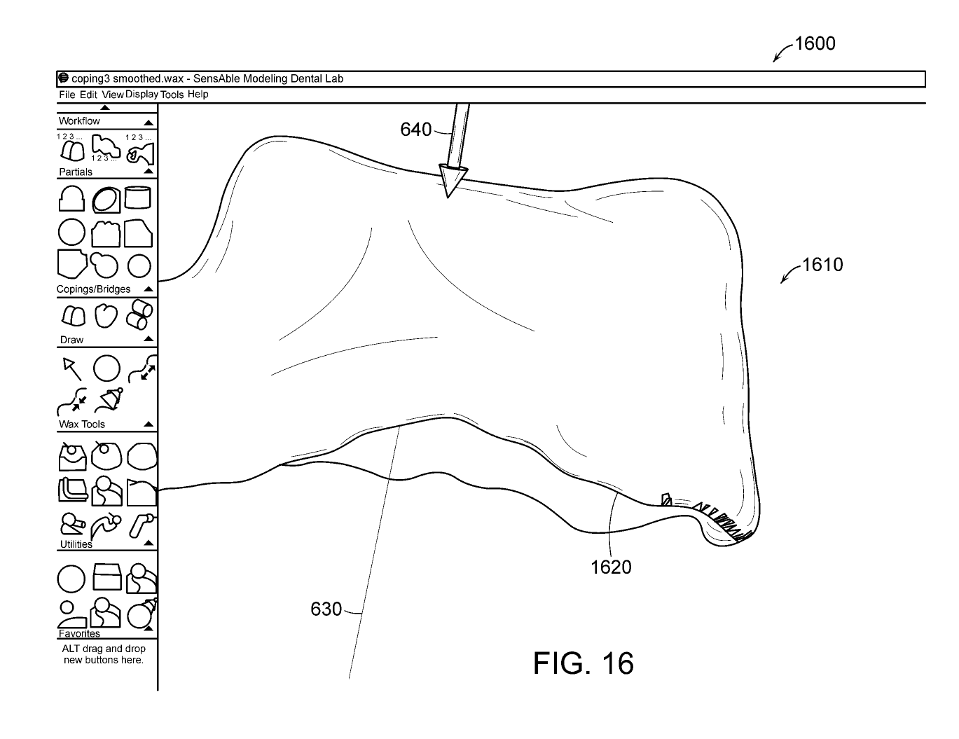

FIG. 16 is a screenshot 1600 showing the final STL version of the exported coping 1610, ready to be sent to the rapid prototyping machine and/or milling machine. The voxel modification from FIG. 15 has been maintained. The margin line 1620 has been precisely remet to the imported scan data.

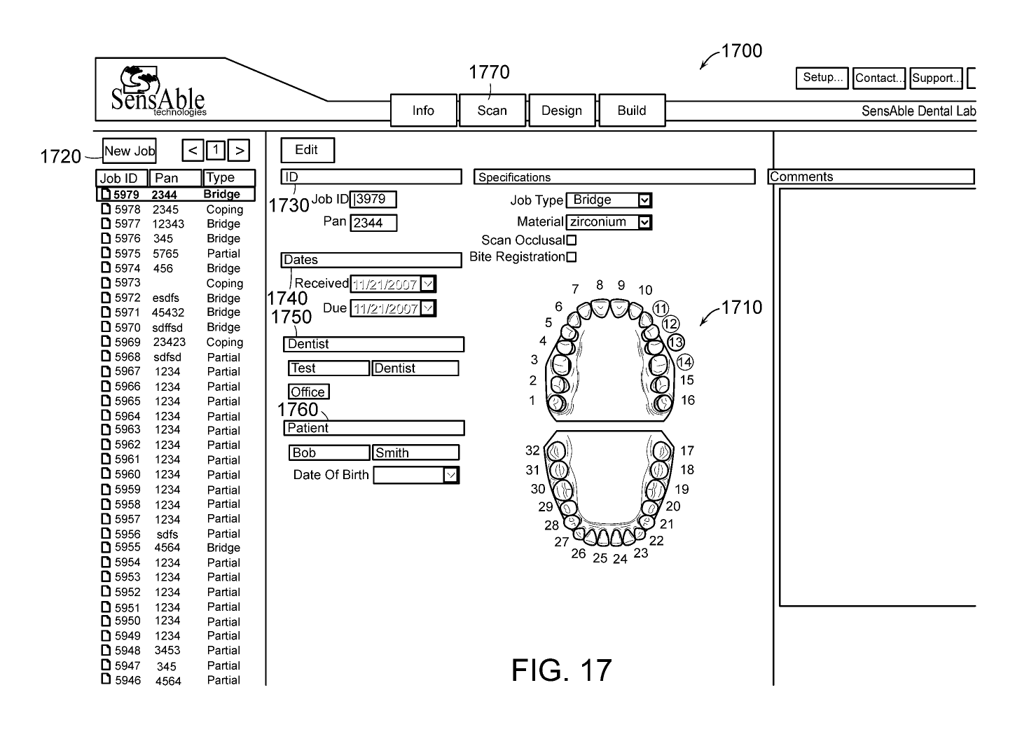

FIG. 17 is a screenshot 1700 of a modeling application showing a case management software screen 1700, which displays information about a particular case. The teeth at issue for the particular dental restoration (labeled as 11, 12, 13, and 14 of the screenshot) are indicated at 1710. Items 1730, 1740, 1750, and 1760 indicate ajob identification, dates, dentist identification, and patient identification. Item 1720 allows creation of a new job (a library ofjobs is indicated directly below). The steps in a given procedure (scan, design, and build) are accessible at item 1770. The case shown in FIG. 17 is for a bridge design, but partials, copings, and other dental restorations are also supported.

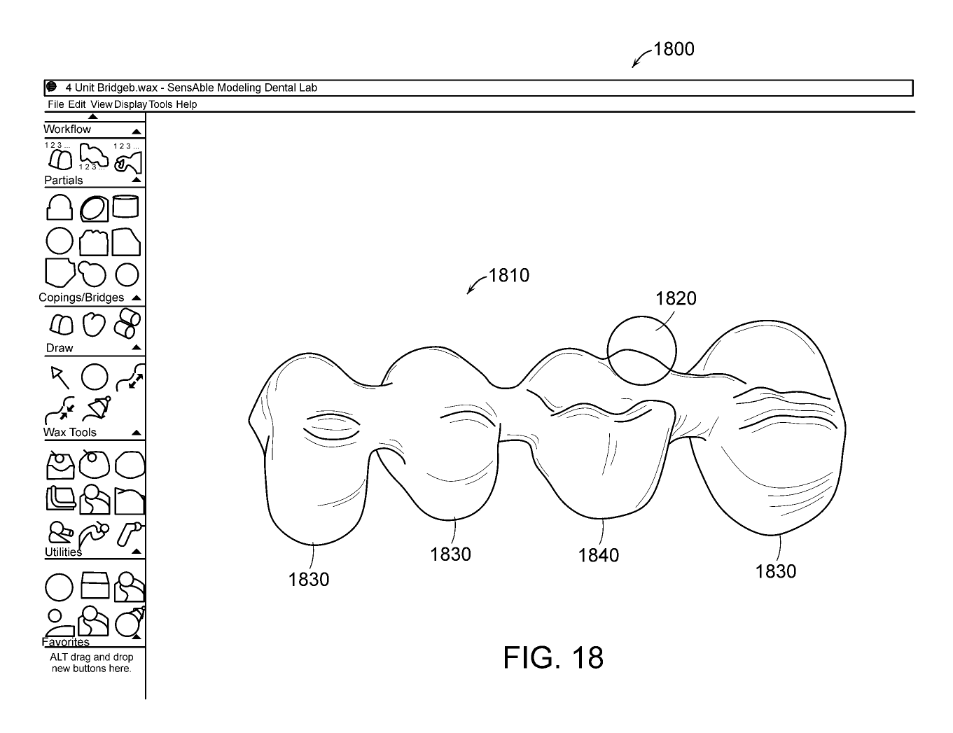

FIG. 18 is a screenshot 1800 of a modeling application showing a designed bridge 1810 with three copings 1830 in digital wax, and a haptic/voxel tug tool 1820 modifying a pontic 1840.

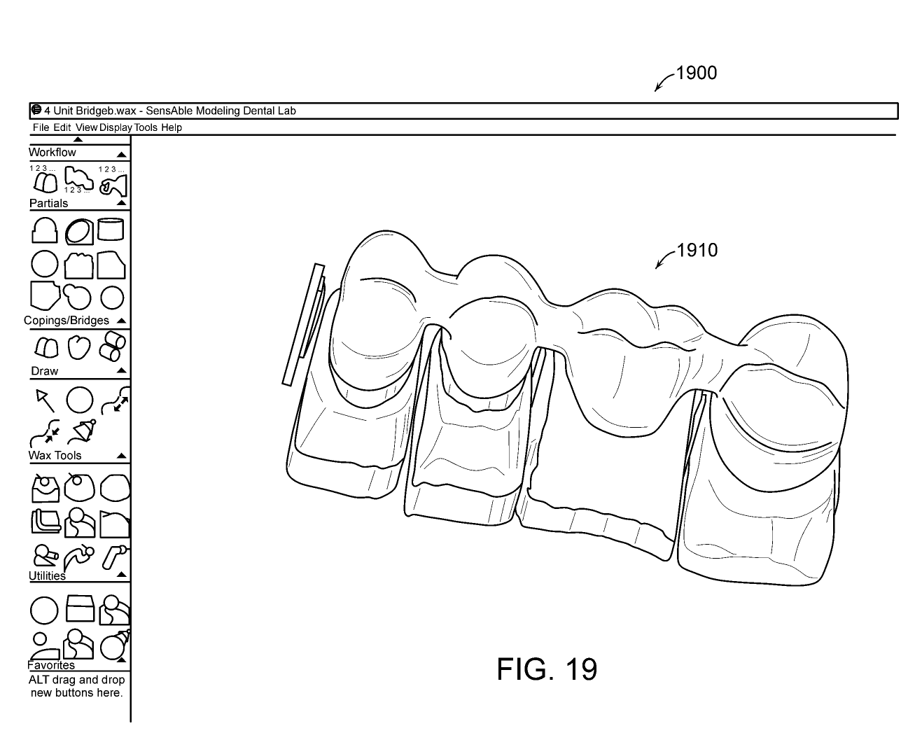

FIG. 19 is a screenshot 1900 of a modeling application showing the completed bridge 1910 superimposed on the input scan file. This is similar to the view of the completed partial on the refractory model described above.

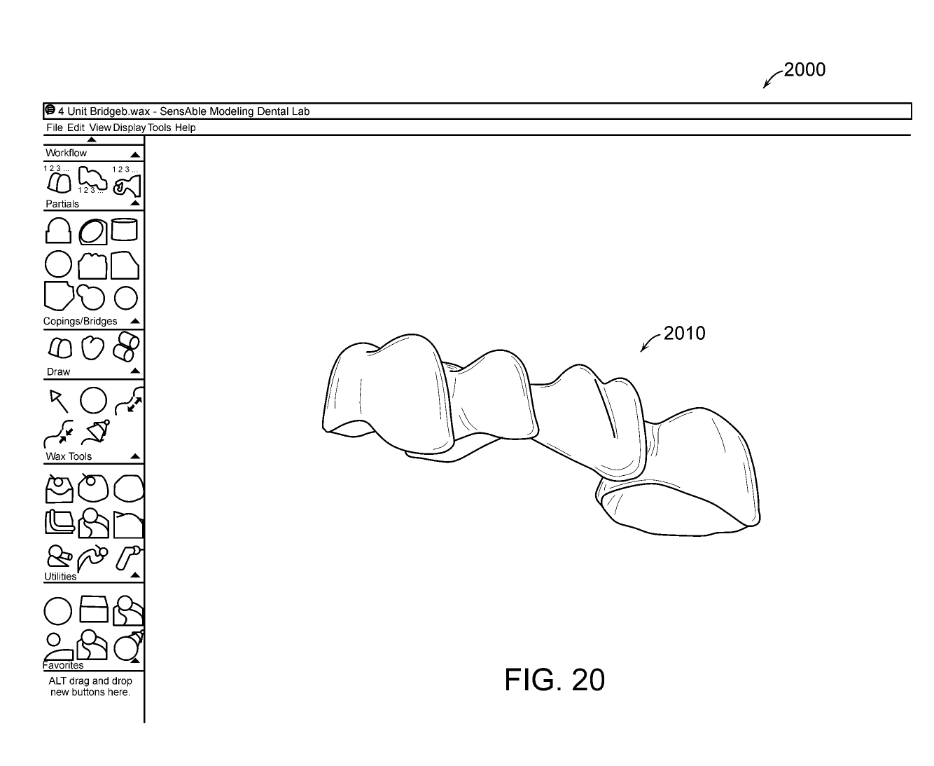

FIG. 20 is a screenshot 2000 of a modeling application showing the STL version of the bridge 2010, ready to be sent to rapid prototyping and/or milling machine(s). Copings have been matched precisely to the initial scan margin (preparation line), while the voxel modifications have been maintained.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A system for creating a three-dimensional dental restoration, the system: comprising:
a scanner configured to obtain scan data corresponding to a patient situation and/or an impression of a patient situation;
computer software that, when operating with a computer and user input, is configured to:
(a) create a model of said patient situation according to said scan data;
(b) identify a preparation line from said model of said patient situation;
(c) create an initial model of a dental restoration conforming to said preparation line and said scan data;
(d) modify said initial model of said dental restoration according to said user input;
(e) determine a force transmitted to a user interacting with said model of said dental restoration via said haptic interface device; and
(f) provide output data corresponding to said modified model of said dental restoration for fabrication of said three-dimensional dental restoration; and
a haptic interface device adapted to provide said user input to said computer and to transmit force to a user.

2. The system of claim 1, wherein said scanner is an intra-oral scanner.

3. The system of claim 1, wherein said scanner comprises multiple light sources and multiple image sensors.

4. The system of claim 1, wherein said scanner is a desktop or benchtop scanner.

5. The system of claim 1, wherein said model of said patient situation is a haptic model.

6. The system of claim 1, wherein said model of said dental restoration is a haptic model.

7. The system of claim 1, wherein said software is configured to automatically and graphically and/or haptically mark areas on said model of said dental restoration according to occlusions with adjacent and/or opposing teeth, for reference by said user in modifying said model of said dental restoration.

8. The system of claim 1, wherein said software is configured to detect and display draft angle conflicts, for reference by said user in modifying said model of said dental restoration.

9. The system of claim 1, wherein said software is configured to determine a valid path of insertion of said three-dimensional dental restoration.

10. The system of claim 9, wherein said software is configured to fix an undercut of said three-dimensional dental restoration.

11. The system of claim 1, wherein said software is configured to automatically identify said preparation line from said model of said patient situation.

12. The system of claim 1, wherein said software is configured to automatically identify an initial preparation line that is adjustable by said user.

13. The system of claim 12, wherein said initial preparation line comprises haptic gravity wells for adjustment by said user.

14. The system of claim 13, wherein said haptic gravity wells operate on a view apparent basis.

15. The system of claim 1, wherein said software is configured to allow haptic user interaction with both said model of said patient situation and said model of said dental restoration.

16. The system of claim 1, wherein said software is configured to model different materials using different densities in a voxel-based model, thereby allowing the user to sense a difference between said different materials.

17. The system of claim 1, further comprising a rapid prototyping machine used for manufacturing a wax model of said three-dimensional dental restoration using said modified model of said dental restoration.

18. The system of claim 17, further comprising an investment cast used for manufacturing said three-dimensional dental restoration from said wax model.

19. The system of claim 18, wherein said three-dimensional dental restoration is a metal partial framework.

20. The system of claim 1, wherein said three-dimensional dental restoration comprises one or more members selected from the group consisting of a partial, a partial framework, a veneer, a coping, a bridge, a multi-unit bridge, a prosthetic tooth, prosthetic teeth, a pontic, an implant, an implant abutment, and an implant bar.

21. The system of claim 1, wherein said model of said patient situation and/or said model of said dental restoration comprises a voxel-based representation.

22. The system of claim 1, wherein said software is configured to generate a NURBS curve approximating said preparation line.

23. The system of claim 1, wherein said software comprises a dental specific feature set comprising one or more geometrical representations selected from the group consisting of voxel-based, polymesh, NURBS patch, NURBS curve, and polyline geometrical representations.

24. The system of claim 1, wherein said software comprises a dental specific feature set comprising two or more geometrical representations selected from the group consisting of voxel-based, polymesh, NURBS patch, NURBS curve, and polyline geometrical representations.

25. The system of claim 1, wherein said software is configured to compensate said model of said dental restoration for material shrinkage during fabrication of said three-dimensional dental restoration.

26. The system of claim 1, wherein said scanner comprises one or more members selected from the group consisting of a visible light scanner, a computed tomography (CT) scanner, a magnetic resonance imaging (MRI) device, and an x-ray machine.

27. The system of claim 1, further comprising a client/server networked environment to accommodate workflow between a practice and a dental lab, wherein said output data corresponding to said modified model of said dental restoration is transmitted from said practice to said dental lab for fabrication of said three-dimensional dental restoration.

28. A method for creating a three-dimensional dental restoration, the method comprising:
(a) obtaining a scan of a patient situation or an impression of a patient situation;
(b) creating a haptic computer model of a dental restoration based at least in part on said scan;
(c) haptically modifying said computer model of said dental restoration; and
(d) fabricating said dental restoration using said haptically modified computer model.

29. The method of claim 28, wherein said haptic computer model comprises a voxel-based representation.

30. The method of claim 28, wherein said haptic computer model comprises a voxel-based representation and a NURBS curve approximating a preparation line for said dental restoration.

31. The method of claim 28, wherein said dental restoration comprises one or more members selected from the group consisting of a partial, a partial framework, a veneer, a coping, a bridge, a multi-unit bridge, a prosthetic tooth, prosthetic teeth, a pontic, an implant, an implant abutment, and an implant bar.

32. A system for creating a dental restoration, the system comprising:
a user-controlled haptic interface device adapted to provide a user input to a computer and to transmit force to a user according to a user interface location in a virtual environment; and
computer software (coded instructions) that, when operating with said computer and said user input, is configured to:
(a) determine force transmitted to said user via said haptic interface device;
(b) allow creation and/or manipulation of a voxel-based haptic representation of a 3D dental restoration in said virtual environment; and
(c) provide output for milling of said 3D dental restoration following creation and/or manipulation of said voxel-based haptic representation.

33. The system of claim 32, further comprising a mill for fabricating said 3D dental restoration.

34. The system of claim 32, wherein said 3D dental restoration comprises one or more of the following: a prosthetic tooth, prosthetic teeth, a bridge, a partial, an implant, an implant bar, and an abutment.

35. A method for creating a dental restoration, the method comprising the steps of:
(a) scanning a patient situation and/or an impression of a patient situation;
(b) creating a haptic, voxel-based representation of said patient situation;
(c) creating a haptic, voxel-based representation of a dental restoration adapted for said patient situation;
(d) modifying said voxel-based representation of said dental restoration; and
(e) fabricating said dental restoration according to said modified representation.

36. An apparatus for creating a dental restoration, the apparatus comprising:
a user-operated haptic interface device;
a memory upon which machine-readable code is stored, the code defining a set of instructions for:
(a) scanning a patient situation and/or an impression of a patient situation;
(b) creating a haptic, voxel-based representation of said patient situation;
(c) creating a haptic, voxel-based representation of a dental restoration adapted for said patient situation;
(d) modifying said voxel-based representation of said dental restoration; and
(e) displaying and/or storing said modified representation of said dental restoration.

37. The apparatus of claim 36, wherein the code further defines instructions for preparing input data from said modified representation of said dental restoration, wherein said input data is usable by a machine for fabrication of said dental restoration.
